(19) United States
(12) Patent Application Publication
(10) Pub. No.: US 2025/0315721 A1
(43) Pub. Date: Oct. 9, 2025

(54) MACHINE LEARNING FRAMEWORKS FOR GENERATING AND LEVERAGING CONTEXTUALIZED ENTITY EMBEDDINGS TAILORED TO DOWNSTREAM PREDICTIVE TASKS

(71) Applicant: Optum Services (Ireland) Limited, Dublin (IE)

(72) Inventors: Conor Power, Dublin (IE); Colum Foley, Dublin (IE); Niamh Murphy, Dublin (IE); Keith Murphy, Dublin (IE)

(21) Appl. No.: 18/628,883

(22) Filed: Apr. 8, 2024

(51) Int. Cl. G06N 20/00

(52) U.S. Cl. CPC G06N 20/00

(57) ABSTRACT

Various embodiments of the present disclosure provide a feature engineering framework for generating task-specific contextual embeddings to improve machine learning model performance, while reducing memory requirements for the performance of a predictive task. The techniques may include identifying a plurality of entity predictive identifiers from historical data objects for an entity. The entity predictive identifiers are used with a task-specific data store to generate a textual entity document for the entity by concatenating a set of contextual text descriptions from the task-specific data store that correspond to a set of task relevant identifiers from the plurality of entity predictive identifiers. The techniques include generating, using a machine learning encoder model, a contextual entity embedding for the entity based on the textual entity document and then training, using the contextual entity embedding, a machine learning classification model for the performance of the predictive task.

### BACKGROUND

Various embodiments of the present disclosure address technical challenges related to feature interpretation and storage for predictive tasks, such as those that leverage machine learning models. Traditionally, machine learning is applied to perform predictive tasks, such as binary classification, among others, by training a model to generate an output based on features represented within an input. The accuracy of various machine learning models is dependent on the information provided by an input and the quality of the predictive features used to train the machine learning model. For example, sparse predictive features that lack contextual information may result in poor machine learning performance. Predictive tasks traditionally rely on observed or recorded data that is available for a particular task. This may involve the use of high-level descriptions of predictive identifiers, such as diagnosis and procedure codes in a clinical use case. Such information may be sparse and/or uninformative and may include portions of information that are irrelevant, redundant, and/or misleading for a particular predictive task. Relying on such data requires the use of robust memory resources to store vast amounts of raw features that may or may not be influential on a predictive task and, due to their various technical deficiencies, reduces the performance of machine learning models trained, using such data, for the particular predictive task.

Various embodiments of the present disclosure make important contributions to traditional feature interpretation and storage techniques to improve the training and performance of machine learning models by addressing these technical challenges, among others.

### BRIEF SUMMARY

Various embodiments of the present disclosure address the above-described technical challenges by providing a feature engineering framework configured to generate contextual embeddings that are tailored to a particular predictive task. As described herein, the performance of a machine learning technique improves with the quality of data and predictive features used to train and as input to the machine learning technique. To improve the quality of predictive features, the feature engineering framework of the present disclosure may filter and then augment traditionally sparse data with contextual and informative textual descriptions. For example, in a clinical domain, a traditionally sparse medical code may be augmented with additional context including text that describes the symptoms of a disease or condition corresponding to the medical code. In some examples, the feature engineering framework may leverage one or more natural language processing capabilities, such as large language models (LLMs), to generate more informative and contextual text-based representations of predictive features. By doing so, text-based descriptions may be generated that provide contextually relevant information and capture semantic relationships missing from traditional identifier descriptions and/or the raw identifiers themselves. Some techniques of the present disclosure may aggregate text descriptions of various predictive identifiers across a unit of time to create filtered and augmented data tailored to a particular predictive task to better capture relationships and dependencies between different categories of predictive identifiers. Using some of the techniques of the present disclosure, the filtered and augmented data may be encoded to generate more informative embedding representations of an entity, which may be leveraged to train and as input to a machine learning model configured to generate predictions for the entity. In this manner, predictive features may be first contextualized and then leveraged to generate contextual entity embeddings that capture both the semantic meaning and context of the underlying predictive features. Once generated, the contextual entity embeddings may be used to perform various training and inference operations to improve the performance of machine learning models with respect to a predictive task.

In some embodiments, a computer-implemented method includes identifying, by one or more processors, a plurality of entity predictive identifiers from one or more historical data objects for an entity; generating, by the one or more processors and using a task-specific data store corresponding to a predictive task, a textual entity document for the entity by concatenating a set of contextual text descriptions from the task-specific data store that correspond to a set of task relevant identifiers from the plurality of entity predictive identifiers; generating, by the one or more processors and using a machine learning encoder model, a contextual entity embedding for the entity based on the textual entity document; and initiating, by the one or more processors and using the contextual entity embedding, one or more training operations for a machine learning classification model configured for the performance of the predictive task.

In some embodiments, a computing system includes memory and one or more processors communicatively coupled to the memory, the one or more processors are configured to identify a plurality of entity predictive identifiers from one or more historical data objects for an entity; generate, using a task-specific data store corresponding to a predictive task, a textual entity document for the entity by concatenating a set of contextual text descriptions from the task-specific data store that correspond to a set of task relevant identifiers from the plurality of entity predictive identifiers; generate, using a machine learning encoder model, a contextual entity embedding for the entity based on the textual entity document; and initiate, using the contextual entity embedding, one or more training operations for a machine learning classification model configured for the performance of the predictive task.

In some embodiments, one or more non-transitory computer-readable storage media includes instructions that, when executed by one or more processors, cause the one or more processors to identify a plurality of entity predictive identifiers from one or more historical data objects for an entity; generate, using a task-specific data store corresponding to a predictive task, a textual entity document for the entity by concatenating a set of contextual text descriptions from the task-specific data store that correspond to a set of task relevant identifiers from the plurality of entity predictive identifiers; generate, using a machine learning encoder model, a contextual entity embedding for the entity based on the textual entity document; and initiate, using the contextual entity embedding, one or more training operations for a machine learning classification model configured for the performance of the predictive task.

### BRIEF DESCRIPTION OF THE DRAWINGS

FIG. 1 provides an example overview of an architecture in accordance with some embodiments of the present disclosure.

FIG. 2 provides an example predictive data analysis computing entity in accordance with some embodiments of the present disclosure.

FIG. 3 provides an example client computing entity in accordance with some embodiments of the present disclosure.

FIG. 4 is a dataflow diagram showing example data structures and modules for engineering contextual entity embeddings for a predictive task in accordance with some embodiments discussed herein.

FIG. 5 is a dataflow diagram showing example data structures and modules for generating a task-specific data store in accordance with some embodiments discussed herein.

FIG. 6 is an operational example of task relevant identifiers and corresponding predefined textual descriptions in accordance with some embodiments discussed herein.

FIG. 7 is an operational example of a class-specific document in accordance with some embodiments discussed herein.

FIG. 8 is an operational example of class-specific frequency scores for automatically identifying a plurality of task relevant identifiers in accordance with some embodiments discussed herein.

FIG. 9 is an operational example of predictive identifiers and corresponding contextual text descriptions in accordance with some embodiments discussed herein.

FIG. 10 is an operational example of one or more stages of a textual entity document in accordance with some embodiments discussed herein.

FIG. 11 is an operational example of contextual entity embeddings for an entity cohort in accordance with some embodiments discussed herein.

FIG. 12 is a flowchart diagram of an example feature engineering process for improving the performance of a predictive task in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

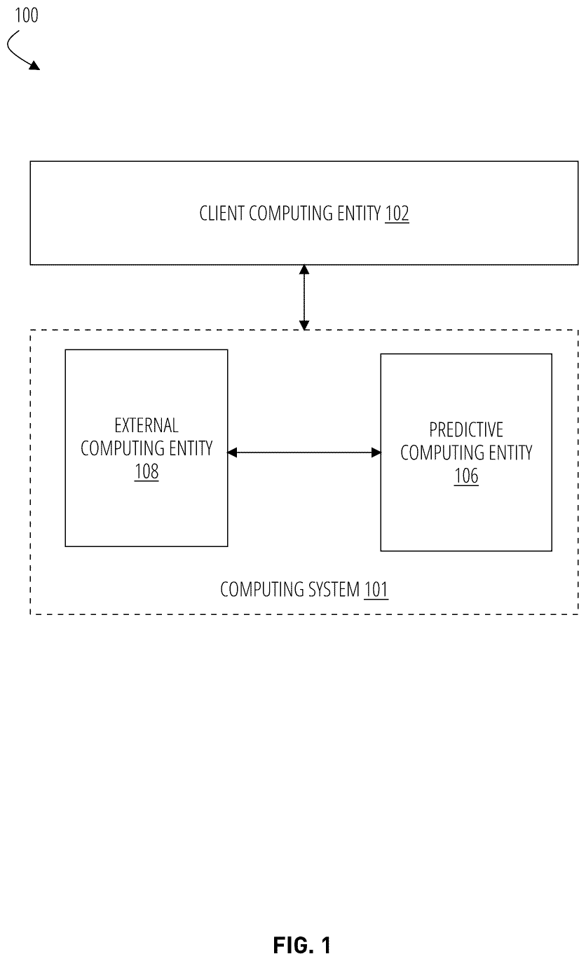

FIG. 1 provides an example overview of an architecture 100 in accordance with some embodiments of the present disclosure. The architecture 100 includes a computing system 101 configured to receive requests, such as generative text requests, from client computing entities 102, process the requests to generate generative text outputs, and provide the generated text outputs to the client computing entities 102. The example architecture 100 may be used in a plurality of domains and not limited to any specific application as disclosed herewith. The plurality of domains may include banking, healthcare, industrial, manufacturing, education, retail, to name a few.

In accordance with various embodiments of the present disclosure, one or more machine learning models may be trained to generate predictive features, such as contextual entity embeddings, and/or the like, predictive insights in various forms, such as predictive classifications, and/or the like. The models may form at least a portion of a feature engineering and training framework that may be configured to generate contextualized predictive features for training a machine learning model for a particular predictive task. This technique will improve the performance of machine learning models through targeted training operations, while reducing processing and memory resource demands for training a machine learning model.

In some embodiments, the computing system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive computing entity 106 and one or more external computing entities 108. The predictive computing entity 106 and/or one or more external computing entities 108 may be individually and/or collectively configured to receive data objects, a predictive classification request for an entity, and/or the like, from client computing entities 102, process the data objects, predictive classification request, and/or the like to generate outputs, such as contextual entity embeddings, predictive classifications, and/or the like, and provide the generated outputs to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data analysis and/or training tasks. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FORAM, NVRAM, MRAM, RRAM, SONOS, FJG RAM, Millipede memory, racetrack memory, and/or the like.

In some embodiments, the predictive computing entity 106 and/or one or more external computing entities 108 are communicatively coupled using one or more wired and/or wireless communication techniques. The respective computing entities may be specially configured to perform one or more steps/operations of one or more techniques described herein. By way of example, the predictive computing entity 106 may be configured to train, implement, use, update, and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., feature engineering techniques, model training techniques, embedding techniques, classification techniques, and/or the like) described herein. The external computing entities 108, for example, may include and/or be associated with one or more entities that may be configured to receive, transmit, store, manage, and/or facilitate datasets, such as the task-specific data store, source data store, training data store, and/or the like. The external computing entities 108, for example, may include data sources that may provide such datasets, and/or the like to the predictive computing entity 106 which may leverage the datasets to perform one or more steps/operations of the present disclosure, as described herein. In some examples, the datasets may include an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for a prediction domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data, etc.) from the use of the machine learning model may be recorded by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Predictive Computing Entity

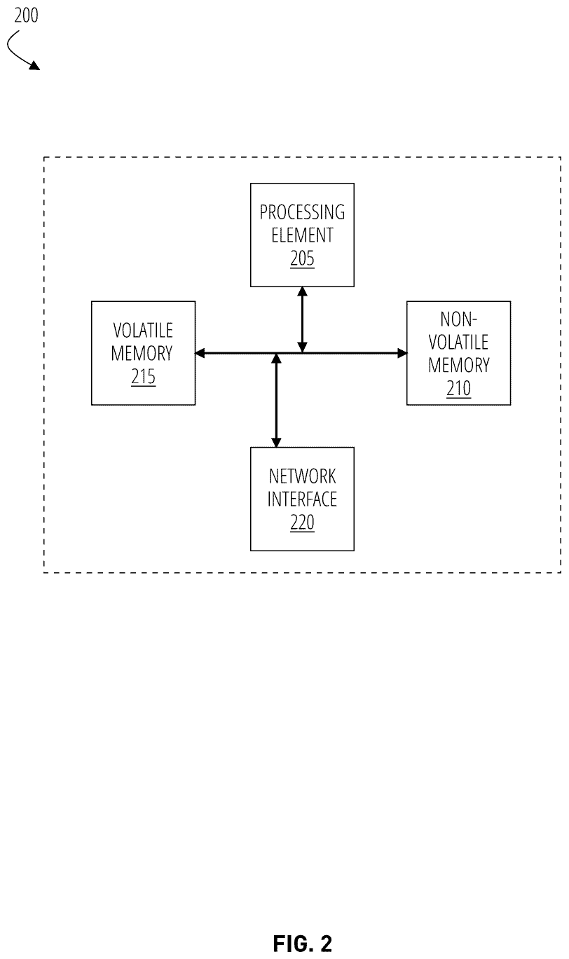

FIG. 2 provides an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106, etc.) may train and use one or more machine learning models described herein. In other embodiments, a first computing entity (e.g., predictive computing entity 106, etc.) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets, etc.) to the first computing entity over a network.

As shown in FIG. 2, in some embodiments, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further include, or be in communication with, non-volatile media (also referred to as non-volatile storage, memory, memory storage, memory circuitry, and/or similar terms used herein interchangeably). In some embodiments, the non-volatile media may include one or more non-volatile memory 210, including, but not limited to, hard disks, ROM, PROM, EPROM, EEPROM, flash memory, MMCs, SD memory cards, Memory Sticks, CBRAM, PRAM, FORAM, NVRAM, MRAM, RRAM, SONOS, FJG RAM, Millipede memory, racetrack memory, and/or the like.

As will be recognized, the non-volatile media may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In some embodiments, the computing entity 200 may further include, or be in communication with, volatile media (also referred to as volatile storage, memory, memory storage, memory circuitry, and/or similar terms used herein interchangeably). In some embodiments, the volatile media may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, code (source code, object code, byte code, compiled code, interpreted code, machine code) that embodies one or more machine learning models or other computer functions described herein, executable instructions, and/or the like being executed by, for example, the processing element 205. Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 with the assistance of the processing element 205 and operating system.

As indicated, in some embodiments, the computing entity 200 may also include one or more network interfaces 220 for communicating with various computing entities (e.g., the client computing entity 102, external computing entities, etc.), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### B. Example Client Computing Entity

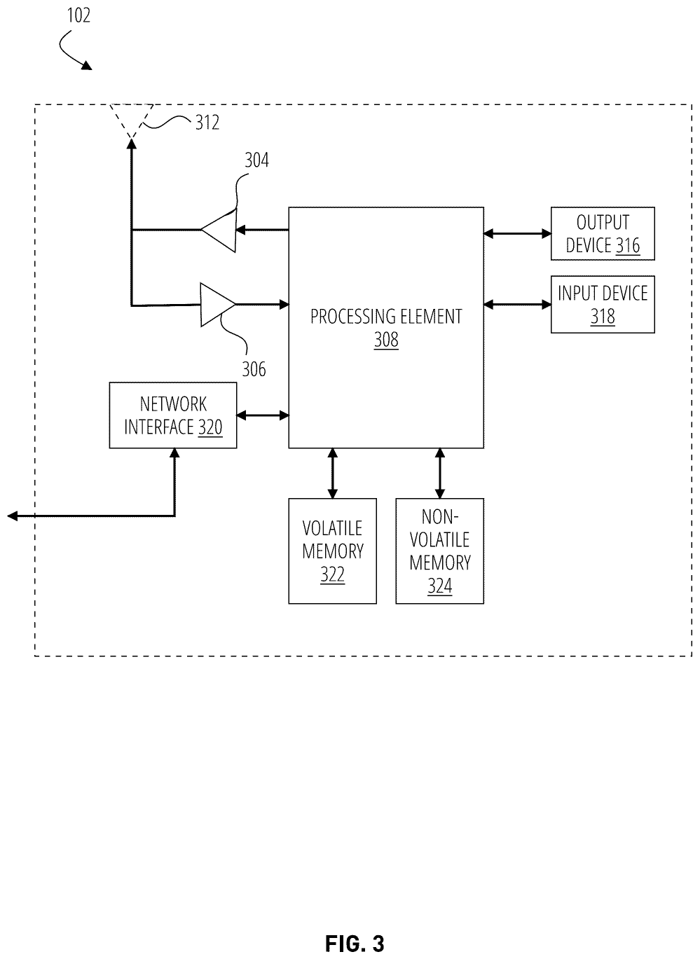

FIG. 3 provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In some embodiments, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 320.

Via these communication standards and protocols, the client computing entity 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download code, changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 318 (or interfaces) allowing the client computing entity 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FORAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, code (source code, object code, byte code, compiled code, interpreted code, machine code, etc.) that embodies one or more machine learning models or other computer functions described herein, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an Al computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. EXAMPLES OF CERTAIN TERMS

In some embodiments, the term “entity” refers to a data element that is subject to a predictive task. An entity, for example, may be associated with a plurality of predictive features that may be leveraged to generate a prediction using various predictive techniques. The predictive features, for example, may include entity predictive identifiers extracted from one or more historical data objects associated with an entity. An entity and/or one or more predictive features thereof may depend on a predictive task. By way of example, for a clinically related predictive task, an entity may include a member of a clinical platform (e.g., an insurance provider, healthcare provider, etc.) and the predictive features of the entity may include clinical identifiers extracted from medical claims to predict a clinical related insight. Other examples of entities may include any subject for which a predictive insight is desired, such as a building, an employee, an animal, a plant, and/or the like.

In some embodiments, the term “historical data object” refers to a data entity that describes one or more historically recorded predictive features of an entity. A historical data object, for example, may include a historical record that records one or more attributes of a historical interaction within a prediction domain. In some examples, a historical data object may include one or more object attributes, predictive features, and/or the like, that may be leveraged by a predictive task to generate predictive insights for an entity. By way of example, for a clinically related predictive task, a historical data object may include a medical claim that may describe a portion of an entity's medical history. Other examples of historical data object may include any recorded data from which a predictive feature may be extracted, including building records, an employment records, and/or the like.

A historical data object may include structured and/or natural language text that describes an entity. The structured and/or natural language text may include one or more entity predictive identifiers that may be predictive of an output from a predictive task.

In some embodiments, the term “entity predictive identifier” refers to a data value that describes a predictive feature for an entity. An entity predictive identifier may include a data value that is extracted from a historical data object associated with an entity for a predictive task. An entity predictive identifier may include any data format, including a numerical, alpha-numerical, alphabetic, and/or the like. In some examples, an entity predictive identifier may include an alpha-numerical code, such as a medical code, a building code, and/or the like. By way of example, in a clinical domain, an entity predictive identifier may include a diagnosis code (e.g., International Classification of Diseases (ICD) code, etc.) and/or a procedure code (e.g., Current Procedural Terminology (CPT) code, etc.).

In some embodiments, the term “task relevant identifier” refers to a predictive identifier that is predictive for a particular predictive task. A task relevant identifier, for example, may include a predictive identifier with a determined relationship to a classification output by a predictive task. In some examples, a task relevant identifier may be identified based one or more historical frequency distributions between a plurality of predictive identifiers and a plurality of ground truth classifications for a prediction task, as described herein.

In some embodiments, the term “predictive task” refers to a computing task configured to generate a predictive insight for an entity. A predictive task, for example, may include one or more machine learning operations for generating a predictive insight based on one or more predictive features of an entity. A predictive task may include any type of machine learning task, including a binary classification task, and/or the like. As some examples, in a clinical domain, a predictive task may include a classification task that leverages machine learning to predict a Medicare status of a member, predict a likelihood that a member will make a medical claim within a set time period, predict a likelihood that a member has an unrecorded disease, and/or the like.

In some examples, an accuracy of one or more machine learning operations of a predictive task may depend on the manipulation and interpretation of one or more predictive features related to an output of the predictive task. To improve the performance of traditional machine learning operations, some of the techniques of the present disclosure may perform one or more feature engineering techniques to generate a contextual entity embedding for an entity that encodes a plurality task relevant identifiers with contextual information that is tailored to a particular predictive task. By doing so, one or more machine learning operations of a predictive task may be trained to generate an output based on a contextual entity embedding that is more predictive of an output of the predictive task.

In some embodiments, the term “contextual entity embedding” refers to a vectorized entity representation that is tailored to a predictive task. A contextual entity embedding, for example, may encode a plurality of predictive features, such as task relevant identifiers, and/or contextual information, such as contextual text descriptions, for the predictive features of an entity. By way of example, a contextual entity embedding may include a fixed length vector that encodes a plurality of contextual text descriptions respectively corresponding to a plurality task relevant identifiers extracted from one or more historical data objects associated with an entity. In some examples, the contextual entity embedding may include an engineered feature input for a machine learning model that is specifically engineered for a predictive task associated with the machine learning model to improve the performance of the machine learning model with respect to the predictive task.

In some embodiments, a contextual entity embedding is generated, using a machine learning encoder model, based on a textual entity document. In some examples, a contextual entity embedding may be generated for each entity in an entity cohort of a prediction domain based on respective textual entity documents. The contextual entity embeddings may enable a representation of predictive features for each of the entities in the form of a plurality of finite dimensional vectors. As the contextual entity embeddings are created from concatenated contextual text descriptions derived from historical data objects (e.g., medical claims in a clinical prediction domain, etc.), they may capture relevant information about an entity, which may be tailored for a specific context. As clinical examples, each contextual entity embedding may encode an understanding a member's physical condition and symptoms for the purposes of determining possible social security benefit eligibility.

In some examples, contextual entity embeddings for an entity cohort may be stored and then accessed for various downstream predictive tasks. For example, the contextual entity embeddings may be leveraged to search for semantically similar entities using a nearest neighbors search, as engineered features for a machine learning model, and/or the like.

In some embodiments, the term “machine learning encoder model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A machine learning encoder model may include any type of model configured, trained, and/or the like to generate a contextual entity embedding, as described herein. A machine learning encoder model may include one or more of any type of machine learning model including one or more supervised, unsupervised, semi-supervised, and/or reinforcement learning models. In some embodiments, the machine learning encoder model may include multiple models configured to perform one or more different stages of an embedding process.

In some embodiments, the machine learning encoder model is a natural language processing model configured to translate a textual entity document to a fixed length vector, such as a contextual entity embedding of the present disclosure. A machine learning encoder model, for example, may include an encoder-only network, an encoder-decoder network, and/or the like. By way of example, a machine learning encoder model may include a neural network architecture with one or more layers that are trained, end-to-end, to transform textual entity documents to fixed length vectors that maintain a semantic similarity between the documents. As one example, a machine learning encoder model may include a Doc2Vec model that is pretrained and/or trained on a domain-specific training data set, such as a task-specific data store, and/or the like.

In some embodiments, the term “textual entity document” refers to a data entity that describes natural language text corresponding to an entity. A textual entity document, for example, may include a set of concatenated contextual text descriptions that respectively correspond to a set of task relevant identifiers extracted from one or more historical data objects associated with an entity. In some examples, a textual entity document may be generated for an entity by receiving the set of contextual text descriptions from a task-specific data store and concatenating the set of contextual text descriptions to form a document descriptive of a plurality of predictive features of an entity with respect to a particular predictive task.

In some embodiments, a textual entity document is generated by concatenating contextual text descriptions that are relevant to both an entity and a predictive task. The relevancy of a contextual text description to an entity and predictive task may be determined by correlating entity predictive identifiers from one or more historical data objects associated with the entity to a task-specific data store. In some examples, contextual text descriptions may be concatenated over a contextual time period (e.g., a temporal-based threshold, such as an entity's lifetime, a year, a month, etc., an event-based threshold initiated after a particular event, such as a birthday, medical emergency, etc.). For instance, the contextual text descriptions of a textual entity document may be identified from entity predictive identifiers extracted from one or more historical data objects that are recorded, assigned, and/or the like, within a contextual time period. In addition, or alternatively, the contextual text descriptions may be concatenated from a single historical data object, such as a most recent historical data object, and/or the like.

In some embodiments, a textual entity document is modified by arranging one or more concatenated contextual text descriptions based on one or more temporal and/or semantic relationships between the concatenated contextual text descriptions. For example, an order in which the one or more concatenated contextual text descriptions are concatenated may be manipulated to better represent temporally and/or semantically related items within a textual entity document. By doing so, related contextual text descriptions may be grouped to capture the contextual information and relationships between the segments of text within the textual entity document. By capturing such relationships, a contextual entity document may provide a basis for creating improved embeddings that are more effective for predictive tasks, as they may better capture the nuances and complexity of the text, leading to a richer representation of an entity.

By way of example, in a clinical domain, contextual text descriptions of a specific diagnosis code may be grouped with contextual text descriptions of procedure codes relating to that diagnosis. The type of procedure performed may help to provide more information on a specific diagnosis. For example, a regularly scheduled blood-test may indicate that a diagnosis for one individual is less severe than the same diagnosis for an individual who has undergone a surgical procedure related to that diagnosis.

In some embodiments, the term “identifier cluster” refers to a plurality of related identifiers associated with a textual entity document. For example, an identifier cluster may include a subset of related task relevant identifiers from a plurality of task relevant identifiers extracted for a textual entity document. In some examples, one or more identifier clusters may be identified using one or more clustering and/or grouping techniques based on a temporal and/or semantic relationship between a plurality of predictive identifiers. In some examples, a temporal and/or semantic relationship between the plurality of predictive identifiers may be defined by a normalized co-occurrence matrix.

In some embodiments, the term “normalized co-occurrence matrix” refers to a data entity that describes one or more temporal and/or semantic relationships between each of a plurality of task relevant identifiers of a predictive task. For example, a normalized co-occurrence matrix may measure a co-occurrence of each of the plurality of task relevant identifiers across a plurality of training data objects (e.g., historical medical claims, etc.). For instance, a normalized co-occurrence matrix may define a relatedness score for each pair of task relevant identifiers of the plurality of task relevant identifiers. A relatedness score for a pair of task relevant identifiers may include a historical count of a number of training data objects that include the pair of task relevant identifiers. In some examples, the relatedness score for each pair of task relevant identifiers may be normalized to represent probabilistic values that a pair of task relevant identifiers are related.

In some embodiments, to determine whether two task relevant identifiers are related, a threshold may be applied to a corresponding normalized co-occurrence score. In the event that the corresponding normalized co-occurrence score achieves the threshold, an identifier cluster may be identified that includes the two task relevant identifiers. In some examples, one or more identifier clusters may be identified for a textual entity document and the contextual text descriptions may be grouped together according to their relatedness.

In some embodiments, the term “training entity” refers to a historical, synthetic, and/or simulated entity that provides one or more training insights for a predictive task. A training entity, for example, may be associated with one or more training data objects that may be processed to generate a normalized co-occurrence matrix and/or one or more insights described herein, such as a task-specific data store.

In some embodiments, the term “task-specific data store” refers to a data structure that describes a plurality of task relevant identifiers and corresponding contextual text descriptions for a predictive task. An example task-specific data store may include any type (and any number) of data storage structures including, as examples, one or more linked lists, databases (e.g., relational databases, graph database, etc.), and/or the like. In some embodiments, a task-specific data store may include a plurality of identifier data objects, each reflective of a task relevant identifier and a contextual text description corresponding to the task relevant identifier.

In some embodiments, a plurality of task relevant identifiers of a task-specific data store may include a subset of a plurality of predictive identifiers from a prediction domain that are tailored to a particular predictive task within the prediction domain. For example, the plurality of task relevant identifiers may be identified from the plurality of predictive identifiers based on a plurality of feature importance measures respectively generated for the plurality of predictive identifiers. By way of example, a plurality of task relevant identifiers may include a subset of a plurality of predictive identifiers with feature importance measures that achieve a relevancy threshold (e.g., zero, etc.). In some examples, a relevancy threshold may be a configurable parameter that may be set based on a performance of a machine learning model configured for a predictive task.

In some embodiments, the term “feature importance measure” refers to a data value that describes a relative importance of a predictive identifier to an outcome of a predictive task. A feature importance measure, for example, may describe a strength of a correlation between a predictive identifier and a negative or positive classification of a binary classification outcome.

In some examples, a robust set of predictive identifiers defined for a prediction domain may be filtered or pruned using a feature importance measure to generate a plurality of task relevant identifiers tailored to a predictive task. The aim of this feature pruning is to retain predictive features relevant to a particular predictive task to improve the semantic information encoded for the particular predictive task. For example, only predictive identifiers likely to contribute to and/or change a predictive classification for an entity may be retained as a task relevant identifier. The likelihood of a predictive identifier contributing to and/or changing a predictive classification for an entity may be reflected by a feature importance measure.

In some embodiments, a feature importance measure is automatically generated for each of a plurality of predictive identifiers with respect to a predictive task. A feature importance measure for a particular predictive identifier may be generated based on a comparison between one or more frequency scores, such as a term frequency-inverse document frequency (TF-IDF) score, for the predictive identifier. The one or more frequency scores, for example, may be generated for each classification of a predictive task.

For example, a class identifier document may be generated for each classification of a predictive task to generate a plurality of class-specific documents for a predictive task. For a binary classification task, the plurality of class-specific documents may include positive class identifier document for a positive class and a negative class identifier document for a negative class. Once the plurality of class-specific documents is generated, a frequency score (e.g., TF-IDF score) of a predictive identifier may be generated for each of the plurality of class-specific documents. The frequency score, for example, may include a TF-IDF score, which may be generated by determining the term frequency (TF) and inverse document frequency (IDF) for the predictive identifier across each of the plurality of class-specific documents using the equation below:

$$TF = \frac{number of times the term appears in the document}{total number of terms in the document}$$

$$IDF = Log ( \frac{n umber of documents in the corpus}{number of documents in the corpus containing the term} )$$

$$TF - IDF = TF \times IDF$$

In some examples, the frequency scores for a predictive identifier may include (i) an average positive TF-IDF score corresponding to a positive class identifier document and (ii) an average negative TF-IDF score corresponding to a negative class identifier document. The average positive TF-IDF score, for example, may include an average TF-IDF score for a predictive identifier amongst a plurality of training entities associated with a positive class (e.g., members that are eligible for Medicare, etc.) of the predictive task. The average negative TF-IDF score may include an average TF-IDF score for a predictive identifier amongst a plurality of training entities associated with a negative class (e.g., members that are not eligible for Medicare, etc.) of the predictive task. A feature importance measure may be generated by subtracting the average negative TF-IDF score from the average positive TF-IDF score.

In some embodiments, the term “positive class identifier document” refers to a plurality of positive training documents for a positive classification of a predictive task. A positive class identifier document, for example, may include a positive training document for each of a plurality of training entities that are associated with a positive classification of a predictive task. Each positive training document may include a concatenation of a plurality of predictive identifiers extracted from one or more historical data objects associated with a respective training entity. In this manner, a plurality of entity-level training documents may be generated for a plurality of training entities associated with a positive classification of a predictive task. Each positive training document may contain a token/term per predictive identifier and may capture predictive identifiers over a timeframe that spans both before and after the assignment of the positive classification to the training entity.

In some embodiments, the term “negative class identifier document” refers to a plurality of negative training documents for a negative classification of a predictive task. A negative class identifier document, for example, may include a negative training document for each of a plurality of training entities that are associated with a negative classification of a predictive task. Each negative training document may include a concatenation of a plurality of predictive identifiers extracted from one or more historical data objects associated with a respective training entity. In this manner, a plurality of entity-level training documents may be generated for a plurality of training entities associated with a negative classification of a predictive task. Each negative training document may contain a token/term per predictive identifier and may capture predictive identifiers over a timeframe that spans both before and after the assignment of the negative classification to the training entity.

In some embodiments, the term “contextual text description” refers to a data entity that describes a segment of natural language text corresponding to a predictive identifier. A contextual text description, for example, may include a sequence of words that describe one or more characteristics of a predictive identifier. In some examples, a contextual text description may include generative text that is output by a machine learning contextualization model in response to a generative text prompt corresponding to a predictive identifier.

For example, a predictive identifier may be associated with a predefined textual description. The predefined textual description may describe a predictive identifier without contextual information. A contextual text description may include an augmented predefined textual description that is augmented with contextual information to add additional context to the predefined textual description. In some examples, a contextual text description may be generated by inputting a generative text prompt, including the predefined textual description, to a machine learning contextualization model. In some examples, for a particular predictive task, a plurality of contextual text descriptions may be generated for all task relevant identifiers in an offline manner to allow for the real time retrieval of contextual text descriptions during the inference.

In some embodiments, the term “machine learning contextualization model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A machine learning contextualization model may include any type of model configured, trained, and/or the like to generate a contextual text description, as described herein. A machine learning contextualization model may include one or more of any type of machine learning model including one or more supervised, unsupervised, semi-supervised, and/or reinforcement learning models. In some embodiments, the machine learning contextualization model may include multiple models configured to perform one or more different stages of a generative text process.

In some examples, a machine learning contextualization model may include a generative model configured to generate natural language text based on a generative prompt. For example, the generative model may include a an LLM, such as a generative pre-trained transformer (GPT) model. In some examples, the generative model may include a GPT-3.5 model and/or any other machine learning model with generative capabilities. The generative model may be configured to generate a contextual text description based on a generative prompt (e.g., a no shot prompt, few shot prompt, etc.) tailored to a predictive identifier.

The additional information provided by the machine learning contextualization model may be tailored to a particular predictive task, where context may be an important factor. For example, in a clinical domain, understanding the symptoms of a condition may help to determine whether an individual's ability to work has been affected, which may help to determine whether they are likely to be eligible for social security benefits, and hence whether they may be eligible for Medicare.

In some embodiments, the term “generative text prompt” refers to a generative model prompt for instructing a machine learning contextualization model to generate a contextual text description. For example, a machine learning contextualization model may be prompted with a generative text prompt to add context to a predictive identifier to provide additional predictive information for use by a downstream machine learning model. A generative text prompt, for example, may include a predefined textual description for a predictive identifier and one or more natural language instructions for augmenting the predefined textual description with information relevant to a predictive task. The one or more natural language instructions, for example, may include one or more configurable parameters that describe one or more contextual considerations associated with a predictive task. By way of example, in a clinical domain, the one or more configurable natural language instructions may request contextual information reflective of one or more symptoms of a condition corresponding to a predictive identifier. In some examples, the one or more configurable natural language instructions of generative text prompt may be dynamically modified based on a performance of a downstream machine learning model for a predictive task.

In some embodiments, the term “predefined textual description” refers to a predefined text segment that corresponds to a predictive identifier. A predefined textual description, for example, may include a text segment from a source data store for a predictive identifier. In some examples, a predefined textual description may be retrieved for a particular predictive identifier from a source data store. An example of a source data store, for example for a clinical prediction domain, may include a Unified Medical Language System repository, a Centers for Medicare & Medicaid Services repository, and/or the like. In some examples, a source data store may be accessed to map a predefined textual description to each of a plurality of predictive identifiers within a prediction domain.

### IV. OVERVIEW

Various embodiments of the present disclosure provide improved feature engineering techniques for improving predictive models with respect to any predictive task, including machine learning based technologies. The improved feature engineering techniques leverage a multi-stage feature engineering framework to generate entity-level contextual embeddings that may be leveraged to generate predictive insights in accordance with a predictive task. The entity-level contextual embeddings may encode both predictive features and contextual information for the predictive features to expand the scope of an input for a predictive task. By doing so, the feature engineering framework may improve the performance of traditional predictive tasks, such as machine learning based technologies, which are traditionally limited to the predictive features of an environment. When applied to machine learning technologies, the feature engineering techniques may enable improved machine learning model training processes that address technical challenges in model training by augmenting traditionally sparse features with predictive contextual insights associated therewith.

For example, traditional approaches to embedding generation focus on generating feature-level embeddings for standalone features, such as medical codes in a clinical domain. In order to aggregate information for discrete units of time or events, these approaches typically aggregate at the embedding level by averaging or summing embedding vectors. This type of aggregation means that important contextual information may be lost in the average or summing of individual vectors. The multi-stage feature engineering framework of the present disclosure addresses the technical challenge of information loss through embedding aggregation by aggregating the unembedded predictive features at the text level before generating an overall embedding. For example, a first stage of the multi-stage feature engineering framework may aggregate and expand upon predictive features at the text level to generate contextual text descriptions. These contextual text descriptions may be leveraged at a second stage of the multi-stage feature engineering framework to generate embeddings without information loss. This approach ensures that important and task significant information is not lost amongst averaged or summed embedding aggregations.

The first stage of the multi-stage feature engineering framework enables the aggregation and expansion of predictive features with contextual information, without increasing memory requirements for performing a predictive task, by filtering a plurality of predictive features to remove features that have low predictive relevance to the predictive task. In this regard, the filtering mechanism of the multi-stage feature engineering framework leverages an improved natural language processing and information retrieval technique to identify context-relevant features for a particular predictive task. The filtering mechanism provides a data-driven approach for scoring a relevance of predictive features with respect to a particular task using a unique combination of frequency scores across a plurality of training data objects.

By filtering a plurality of predictive features down to task relevant identifiers, the first stage of the multi-stage feature engineering framework enables an application of complex pre-processing operations for expanding the semantic significance of the task relevant identifiers. To do so, the multi-stage feature engineering framework may perform an LLM-based generation of a contextual text description for each of the task relevant identifiers. In this way, contextual text descriptions may be generated that derive additional valuable information previously unavailable from a predictive identifier.

The second stage of the multi-stage feature engineering framework may build upon the first stage by selectively extracting contextual text descriptions for a particular entity. Once extracted, the contextual text descriptions any be arranged to emphasize temporal and semantic relationships between the task relevant identifiers associated with the contextual text descriptions. By doing so, the second stage of the multi-stage feature engineering framework may create a textual document that represents semantically and contextually rich information for an entity. This information may be encoded to generate embeddings that capture the semantically and contextually rich information for the entity within a finite sized vector with a small memory footprint. In this manner, the multi-stage feature engineering framework enable the generation, storage, retrieval, and use of engineered feature vectors that are more predictive of and tailored to a predictive outcome of a predictive task. This, in turn, may improve the performance of downstream predictive tasks, including those that leverage machine learning techniques.

Examples of technologically advantageous embodiments of the present disclosure include: (i) feature engineering techniques for generating semantically rich features tailored to a predictive task, (ii) embedding techniques for generating entity level embeddings, and (iii) machine learning training techniques that address sparse feature spaces, among other aspects of the present disclosure. Other technical improvements and advantages may be realized by one of ordinary skill in the art.

### V. EXAMPLE SYSTEM OPERATIONS

As indicated, various embodiments of the present disclosure make important technical contributions to feature engineering and machine learning technologies that are practically applied to improve the training and performance of machine learning model with respect to various predictive tasks. In particular, systems and methods are disclosed herein that implement a multi-stage feature engineering framework to generate and then encode contextual information for traditionally sparse predictive features within a prediction domain. Once encoded, the contextualize information may augment the traditionally sparse predictive features during one or more training or inference operations of a machine learning model. By doing so, the performance of a machine learning model may be improved with respect to a predictive task using contextualized embeddings that require a small memory footprint. This, in turn, enables tailored machine learning training operations without increases to the memory requirements of a system.

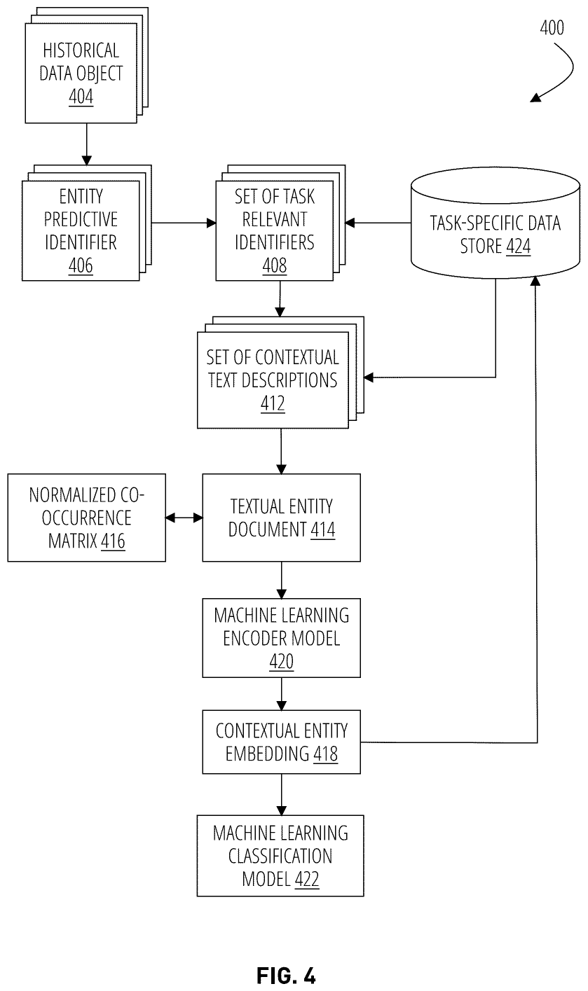

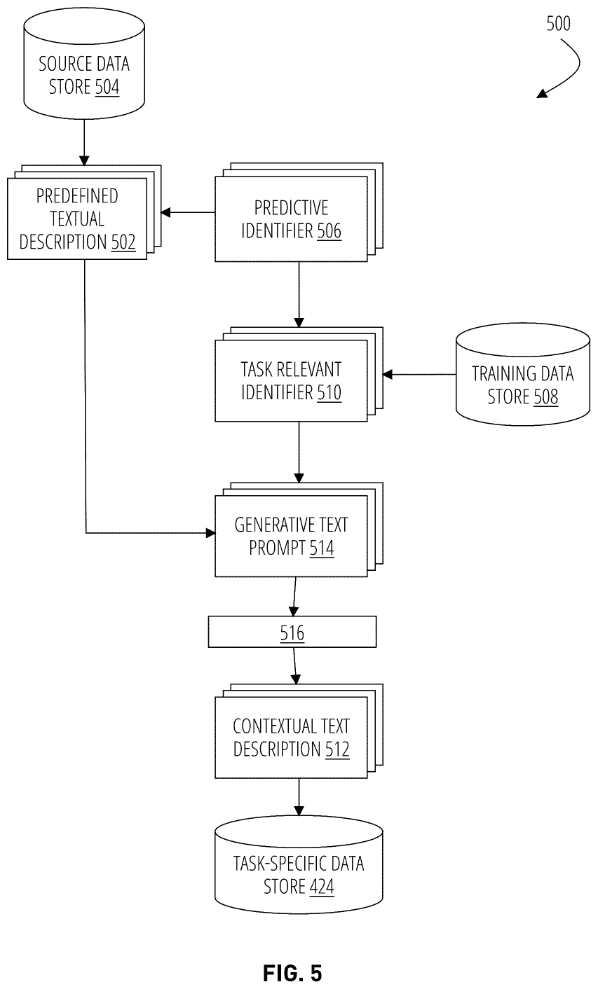

FIG. 4 is a dataflow diagram 400 showing example data structures and modules for engineering contextual entity embeddings for a predictive task in accordance with some embodiments discussed herein. The dataflow diagram 400 includes a specific set of a plurality of data structures that form a first stage of a feature engineering framework configured to generate contextual entity embeddings 418 for an entity and/or a cohort of entities associated with a predictive task. The first stage of the feature engineering framework, for example, may include an encoding portion that leverages a task-specific data store 424 to identify contextual information that is tailored to the predictive task. The contextual information may be curated in a second, data engineering stage of the feature engineering framework described with reference to FIG. 5. In some examples, encoding stage of the feature engineering framework may include a plurality of online operations configured to dynamically generate contextual entity embeddings 418 for an entity by processing one or more historical data objects 404 for the entity with a task-specific data store 424. By doing so, contextual and relevant, task-specific information may be extracted and expanded from the historical data objects 404 to generate contextual entity embeddings 418 with improved predictive quality relative to traditionally engineered features for a predictive task. Ultimately, enables improved machine learning performance by providing improved features to a downstream model, such as the machine learning classification model 422 illustrated in the dataflow diagram 400.

In some embodiments, a plurality of entity predictive identifiers 406 is identified from one or more historical data objects 404 for an entity. In some embodiments, an entity is a data element that is subject to a predictive task. The entity, for example, may be associated with a plurality of predictive features that may be leveraged to generate a prediction using various predictive techniques. The predictive features, for example, may include entity predictive identifiers 406 extracted from one or more historical data objects 404 associated with the entity. The entity and/or one or more predictive features thereof may depend on the predictive task. By way of example, for a clinically related predictive task, an entity may include a member of a clinical platform (e.g., an insurance provider, healthcare provider, etc.) and the predictive features of the entity may include clinical identifiers extracted from medical claims to predict a clinical related insight. Other examples of entities may include any subject for which a predictive insight is desired, such as a building, an employee, an animal, a plant, and/or the like.

In some embodiments, a predictive task is a computing task configured to generate a predictive insight for an entity. A predictive task, for example, may include one or more machine learning operations, such as those performed by the machine learning classification model 422, for generating a predictive insight based on one or more predictive features of an entity. A predictive task may include any type of machine learning task, including a binary classification task, and/or the like. As some examples, in a clinical domain, a predictive task may include a classification task that leverages machine learning to predict a Medicare status of a member, predict a likelihood that a member will make a medical claim within a set time period, predict a likelihood that a member has an unrecorded disease, and/or the like.

In some examples, an accuracy of one or more machine learning operations of a predictive task may depend on the manipulation and interpretation of one or more predictive features related to an output of the predictive task. To improve the performance of traditional machine learning operations, some of the techniques of the present disclosure may perform one or more feature engineering techniques to generate a contextual entity embedding 418 for an entity that encodes a set of task relevant identifiers 408 with contextual information that is tailored to a particular predictive task. By doing so, one or more machine learning operations of a predictive task may be trained to generate an output based on the contextual entity embedding 418 that is more predictive of an output of the predictive task.

In some embodiments, the historical data objects 404 include data entities that describe one or more historically recorded predictive features of the entity. A historical data object 404, for example, may include a historical record that records one or more attributes of a historical interaction within a prediction domain. In some examples, the historical data object 404 may include one or more object attributes, predictive features, and/or the like, that may be leveraged by a predictive task to generate predictive insights for an entity. By way of example, for a clinically related predictive task, a historical data object 404 may include a medical claim that may describe a portion of an entity's medical history. Other examples of historical data objects 404 may include any recorded data from which a predictive feature may be extracted, including building records, an employment records, and/or the like.

The historical data objects 404 may include structured and/or natural language text that describes the entity. The structured and/or natural language text may include one or more entity predictive identifiers 406 that may be predictive of an output from a predictive task.

In some embodiments, the entity predictive identifiers 406 are data values that respectively describe a predictive feature for the entity. The entity predictive identifiers 406 may include data values that are extracted from the historical data objects 404 associated with the entity for a predictive task. The entity predictive identifiers 406 may include any data format, including a numerical, alpha-numerical, alphabetic, and/or the like. In some examples, the entity predictive identifiers 406 may include an alpha-numerical code, such as a medical code, a building code, and/or the like. By way of example, in a clinical domain, the entity predictive identifiers 406 may include a diagnosis code (e.g., International Classification of Diseases (ICD) code, etc.) and/or a procedure code (e.g., Current Procedural Terminology (CPT) code, etc.).

In some embodiments, a textual entity document 414 is generated for the entity based on the plurality of entity predictive identifier 406. For example, the textual entity document 414 may be generated using a task-specific data store 424 corresponding to a predictive task. For example, a set of task relevant identifiers 408 may be identified from the plurality of entity predictive identifiers 406 based on a comparison between the plurality of entity predictive identifiers 406 and a plurality of task relevant identifiers from the task-specific data store 424.

In some embodiments, a task relevant identifier is a predictive identifier that is predictive for a particular predictive task. A task relevant identifier, for example, may include a predictive identifier with a determined relationship to a classification output by a predictive task, such as an output of the machine learning classification model 422. In some examples, a task relevant identifier may be identified based one or more historical frequency distributions between a plurality of predictive identifiers and a plurality of ground truth classifications for a prediction task, as described herein with reference to FIG. 5.

In some embodiments, the task-specific data store 424 is a data structure that describes a plurality of task relevant identifiers and corresponding contextual text descriptions for a predictive task. An example task-specific data store 424 may include any type (and any number) of data storage structures including, as examples, one or more linked lists, databases (e.g., relational databases, graph database, etc.), and/or the like. In some embodiments, the task-specific data store 424 may include a plurality of identifier data objects, each reflective of a task relevant identifier and a contextual text description corresponding to the task relevant identifier.

In some embodiments, the textual entity document 414 is generated by concatenating a set of contextual text descriptions 412 from the task-specific data store 424 that correspond to the set of task relevant identifiers 408 from the plurality of entity predictive identifiers 406. For example, the set of contextual text descriptions 412 may correspond to the set of task relevant identifiers 408. The set of contextual text descriptions 412 may be received from the task-specific data store 424 based on the set of task relevant identifiers 408. In some examples, the textual entity document 414 may be generated by concatenating the set of contextual text descriptions 412.

In some embodiments, a contextual text description is data entity that describes a segment of natural language text corresponding to a predictive identifier. A contextual text description, for example, may include a sequence of words that describe one or more characteristics of a predictive identifier. In some examples, a contextual text description may include generative text that is output by a machine learning contextualization model in response to a generative text prompt corresponding to a predictive identifier, as described with reference to FIG. 5.

In some embodiments, the textual entity document 414 is a data entity that describes natural language text corresponding to an entity. The textual entity document 414, for example, may include a concatenated set of contextual text descriptions 412 that respectively correspond to the set of task relevant identifiers 408 extracted from one or more historical data objects 404 associated with an entity. In some examples, the textual entity document 414 may be generated for an entity by receiving the set of contextual text descriptions 412 from a task-specific data store 424 and concatenating the set of contextual text descriptions 412 to form a document descriptive of a plurality of predictive features of an entity with respect to a particular predictive task.

In some embodiments, the textual entity document 414 is generated by concatenating contextual text descriptions that are relevant to both an entity and a predictive task. The relevancy of a contextual text description to an entity and predictive task may be determined by correlating entity predictive identifiers 406 from one or more historical data objects 404 associated with the entity to a task-specific data store 424. In some examples, contextual text descriptions may be concatenated over a contextual time period (e.g., a temporal-based threshold, such as an entity's lifetime, a year, a month, etc., an event-based threshold initiated after a particular event, such as a birthday, medical emergency, etc.). For instance, the contextual text descriptions of the textual entity document 414 may be identified from entity predictive identifiers extracted from one or more historical data objects that are recorded, assigned, and/or the like, within a contextual time period. In addition, or alternatively, the contextual text descriptions may be concatenated from a single historical data object, such as a most recent historical data object, and/or the like.

In some embodiments, a textual entity document 414 is modified by arranging one or more concatenated contextual text descriptions based on one or more temporal and/or semantic relationships between the concatenated contextual text descriptions. For example, an order in which the one or more concatenated contextual text descriptions are arranged may be manipulated to better represent temporally and/or semantically related items within the textual entity document 414 to improve the richness of an embedding derived therefrom. By doing so, related contextual text descriptions may be grouped to capture the contextual information and relationships between the segments of text within the textual entity document 414. By capturing such relationships, the textual entity document 414 may provide a basis for creating improved embeddings that are more effective for predictive tasks, as they may better capture the nuances and complexity of the text, leading to a richer representation of an entity.

By way of example, in a clinical domain, contextual text descriptions of a specific diagnosis code may be grouped with contextual text descriptions of procedure codes relating to that diagnosis. The type of procedure performed may help to provide more information on a specific diagnosis. For example, a regularly scheduled blood-test may indicate that a diagnosis for one individual is less severe than the same diagnosis for an individual who has undergone a surgical procedure related to that diagnosis.

In some embodiments, the textual entity document 414 is modified to arrange one or more contextual text descriptions of the set of contextual text descriptions 412 in accordance with one or more feature prioritization techniques. For example, one or more identifier clusters may be identified from the set of task relevant identifiers 408. The identifier clusters, for example, may be identifier using a normalized co-occurrence matrix 416. Each identifier cluster may include a subset of related task relevant identifiers from the set of task relevant identifiers 408. In some examples, the textual entity document 414 may be modified by grouping a subset of contextual text descriptions from the set of contextual text descriptions 412 that correspond to the subset of related task relevant identifiers.

In some embodiments, the normalized co-occurrence matrix is generated based on a plurality of identifier frequencies across a plurality of historical data objects for a plurality of training entities. The plurality of identifier frequencies may identify a co-occurrence count reflective of a number of historical data objects that include a first predictive identifier and a second predictive identifier. In some examples, the normalized co-occurrence matrix 416 includes a normalized co-occurrence measure for the first predictive identifier and the second predictive identifier that is based on the co-occurrence count and a number of the plurality of historical data objects.

In some embodiments, an identifier cluster is a plurality of related identifiers associated with the textual entity document 414. For example, an identifier cluster may include a subset of related task relevant identifiers from a set of task relevant identifiers 408 extracted for the textual entity document 414. In some examples, one or more identifier clusters may be identified using one or more clustering and/or grouping techniques based on a temporal and/or semantic relationship between a plurality of predictive identifiers. In some examples, a temporal and/or semantic relationship between the plurality of predictive identifiers may be defined by the normalized co-occurrence matrix 416.

In some embodiments, the normalized co-occurrence matrix 416 is a data entity that describes one or more temporal and/or semantic relationships between each of a plurality of task relevant identifiers of a predictive task. For example, the normalized co-occurrence matrix 416 may measure a co-occurrence of each of the plurality of task relevant identifiers across a plurality of training data objects (e.g., historical medical claims, etc.). For instance, the normalized co-occurrence matrix 416 may define a relatedness score for each pair of task relevant identifiers of a plurality of task relevant identifiers. A relatedness score for a pair of task relevant identifiers may include a historical count of a number of training data objects that include the pair of task relevant identifiers. In some examples, the relatedness score for each pair of task relevant identifiers may be normalized to represent probabilistic values that a pair of task relevant identifiers are related.

In some embodiments, to determine whether two task relevant identifiers are related, a threshold may be applied to a corresponding normalized co-occurrence score. In the event that the corresponding normalized co-occurrence score achieves the threshold, an identifier cluster may be identified that includes the two task relevant identifiers. In some examples, one or more identifier clusters may be identified for the textual entity document and the contextual text descriptions may be grouped together according to their relatedness.

In some embodiments, a contextual entity embedding 418 is generated for the entity based on the textual entity document 414. For example, the contextual entity embedding 418 may be generated using a machine learning encoder model 420. In some examples, the machine learning encoder model 420 may include a neural network architecture and the contextual entity embedding 418 may include a fixed length numerical vector representing a semantic relationship between the set of task relevant identifiers 408 and the predictive task.

In some embodiments, the contextual entity embedding 418 is a vectorized entity representation that is tailored to a predictive task. The contextual entity embedding 418, for example, may encode a plurality of predictive features, such as task relevant identifiers, and/or contextual information, such as contextual text descriptions, for the predictive features of an entity. By way of example, the contextual entity embedding 418 may include a fixed length vector that encodes a plurality of contextual text descriptions respectively corresponding to a plurality task relevant identifiers extracted from one or more historical data objects 404 associated with an entity. In some examples, the contextual entity embedding 418 may include an engineered feature input for a machine learning model, such as the machine learning classification model 422, that is specifically engineered for a predictive task associated with the machine learning model to improve the performance of the machine learning model with respect to the predictive task.

In some embodiments, the contextual entity embedding 418 is generated, using a machine learning encoder model 420, based on the textual entity document 414. In some examples, a contextual entity embedding 418 may be generated for each entity in an entity cohort of a prediction domain based on respective textual entity documents 414. The contextual entity embeddings 418 may enable a representation of predictive features for each of the entities in the form of a plurality of finite dimensional vectors. As the contextual entity embeddings 418 are created from concatenated contextual text descriptions derived from historical data objects 404 (e.g., medical claims in a clinical prediction domain, etc.), they may capture relevant information about an entity, which may be tailored for a specific context. As clinical examples, each contextual entity embedding 418 may encode an understanding a member's physical condition and symptoms for the purposes of determining possible social security benefit eligibility, among other clinically related predictive tasks.

In some examples, contextual entity embeddings 418 for an entity cohort may be stored and then accessed for various downstream predictive tasks. For example, the contextual entity embeddings 418 may be leveraged to search for semantically similar entities using a nearest neighbors search, as engineered features for a machine learning model, and/or the like. The contextual entity embedding 418 may be stored in an embedding data store, as part of the task-specific data store 424, and/or the like.

In some embodiments, the machine learning encoder model 420 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The machine learning encoder model 420 may include any type of model configured, trained, and/or the like to generate a contextual entity embedding 418, as described herein. The machine learning encoder model 420 may include one or more of any type of machine learning model including one or more supervised, unsupervised, semi-supervised, and/or reinforcement learning models. In some embodiments, the machine learning encoder model 420 may include multiple models configured to perform one or more different stages of an embedding process.

In some embodiments, the machine learning encoder model 420 is a natural language processing model configured to translate a textual entity document 414 to a fixed length vector, such as a contextual entity embedding 418 of the present disclosure. The machine learning encoder model 420, for example, may include an encoder-only network, an encoder-decoder network, and/or the like. By way of example, the machine learning encoder model 420 may include a neural network architecture with one or more layers that are trained, end-to-end, to transform textual entity documents 414 to fixed length vectors that maintain a semantic similarity between the documents. As one example, a machine learning encoder model 420 may include a Doc2Vec model that is pretrained and/or trained on a domain-specific training data set, such as the task-specific data store 424, and/or the like. Other examples of a machine learning encoder model 420 may include Top2Vec, Word2Vec, Bag of Words, and/or any other encoding model.

In some embodiments, a machine learning classification model 422 is trained for the performance of the predictive task using the contextual entity embedding 418. By way of example, a machine learning classification model 422 may be trained, using one or more machine learning training techniques, to generate a classification for an entity based on a contextual entity embedding. The machine learning classification model 422 may be trained using training data (e.g., from the task-specific data store 424, a training data store, etc.) that includes a plurality of training entities, contextual entity embeddings, and corresponding training labels. In some examples, the machine learning classification model 422 may be trained, via backpropagation of errors, to optimize a loss function based on the contextual entity embeddings and corresponding training labels. In this manner, the machine learning classification model 422 may learn to leverage a contextual entity embedding to generate more accurate classifications for a predictive task.

In some embodiments, the machine learning classification model 422 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The machine learning classification model 422 may include any type of model configured, trained, and/or the like to generate a contextual entity embedding 418, as described herein. The machine learning classification model 422 may include one or more of any type of machine learning model including one or more supervised, unsupervised, semi-supervised, and/or reinforcement learning models. In some embodiments, the machine learning classification model 422 may include multiple models configured to perform one or more different stages of a predictive task.

In some embodiments, the machine learning classification model 422 is a machine learning classifier, such as binary classification model, multi-class classification model, and/or the like, that is configured to generate a classification for an input data object. By way of example, the machine learning classification model 422 may include a supervised machine learning model including one or more different model architectures, such as one or more neural networks, decision trees, and/or the like. The machine learning classification model 422 may be trained, via one or more supervisory training techniques, to generate a classification responsive to one or more predictive features for an entity. Traditionally, the machine learning classification model 422 may be trained using sparse features that may be unrelated, redundant, misleading, or lack context with respect to a predictive task. To improve the performance of the machine learning classification model 422, the machine learning classification model 422 may be reconfigured, trained, and/or the like to generate classifications based on the contextual entity embeddings 418 of the present disclosure.

As described herein, contextual entity embeddings 418 may be generated for each of a plurality of entities within a prediction domain for use as engineered features for a machine learning classification model 422 and/or any other component of a predictive task. By doing so, an encoding stage of a feature engineering framework may improve the functioning of machine learning model by generating highly predictive inputs for both training a model and then inferring predictions using the improved model. The contextual information encoded during the encoding stage of the feature engineering framework may be curated in a second, data engineering stage of the feature engineering framework, which is described in further detail with reference to FIG. 5.

FIG. 5 is a dataflow diagram 500 showing example data structures and modules for generating a task-specific data store 424 in accordance with some embodiments discussed herein. The dataflow diagram 500 includes a specific set of a plurality of data structures that form a second stage of a feature engineering framework configured to generate contextual entity embeddings 418 for an entity and/or a cohort of entities associated with a predictive task. The second stage of the feature engineering framework, for example, may include an data engineering portion that leverages a specific combination source data, from a source data store 504, training data, from a training data store 508, and generative machine learning models, such as the machine learning contextualization model 516, to curate a plurality of task relevant identifiers 510 for a predictive task and generate contextual text descriptions 512 for each of the task relevant identifier 510. By doing so, the data engineering portion of the feature engineering framework may enable the generation of task-specific data stores 424 for any predictive task that narrows a large set of candidate predictive identifiers 506 to those relevant to a predictive task and then expands the contextual information available for the task relevant identifiers 510. Ultimately, this enables improved machine learning performance by empowering the creation of improved features for a downstream model, as described with reference to FIG. 4.

In some embodiments, a plurality of task relevant identifiers 510 is identified for a predictive task from a plurality of predictive identifiers 506. The task relevant identifiers 510 may be stored in the task-specific data store 424. For example, the plurality of task relevant identifiers 510 of the task-specific data store 424 may include a subset of a plurality of predictive identifiers 506 from a prediction domain that are tailored to a particular predictive task within the prediction domain. In some examples, the plurality of task relevant identifiers 510 may be identified from a plurality of predictive identifiers 506 defined by one or more source data stores 504. A source data store 504, for example, may include an internal and/or external data source that codifies, defines, and/or the like one or more predictive identifiers 506 for a prediction domain. An example of a source data store 504, for example for a clinical prediction domain, may include a Unified Medical Language System repository, a Centers for Medicare & Medicaid Services repository, and/or the like.

In some embodiments, the plurality of task relevant identifiers 510 is identified from the plurality of predictive identifiers 506 based on a plurality of feature importance measures respectively generated for the plurality of predictive identifiers 506. By way of example, a plurality of task relevant identifiers 510 may include a subset of a plurality of predictive identifiers 506 with feature importance measures that achieve a relevancy threshold (e.g., zero, etc.). In some examples, a relevancy threshold may be a configurable parameter that may be set based on a performance of a machine learning model configured for a predictive task.

In some embodiments, a predictive task may include a binary classification task and the plurality of task relevant identifiers 510 may be identified based on a feature importance measure generated from a positive class identifier document and a negative class identifier document. The positive class identifier document and the negative class identifier document, for example, may be generated using a plurality of historical data objects from a training data store 508. The training data store 508, for example, may include a plurality of training data objects respectively associated with a plurality of training entities. A training entity, for example, may be a historical, synthetic, and/or simulated entity that provides one or more training insights for a predictive task. For example, a training entity may be associated with one or more training data objects that may be processed to identify one or more historical correlations between a plurality of predictive identifiers 506 and a predictive task. The historical correlations, for example, may include feature importance measures derived from class-specific documents, normalized co-occurrence matrices, as described with reference to FIG. 4, and/or one or more other insights that may contribute to a task-specific data store 424 and/or contextual entity embedding.

In some examples, a positive class identifier document for a binary classification task may be generated using the training data store 508. For example, the positive class identifier document may be generated by identifying a first plurality of training entities from the training data store 508 that are associated with a positive class of the binary classification task. A first plurality of historical data objects may be received from the training data store 508 that correspond to the first plurality of training entities. The positive class identifier document may be generated by concatenating a plurality of positive class identifiers from each of the first plurality of historical data objects.

In some embodiments, the positive class identifier document includes plurality of positive training documents for a positive classification of a predictive task. A positive class identifier document, for example, may include a positive training document for each of a plurality of training entities that are associated with a positive classification of a predictive task. Each positive training document may include a concatenation of a plurality of predictive identifiers extracted from one or more historical data objects associated with a respective training entity. In this manner, a plurality of entity-level training documents may be generated for a plurality of training entities associated with a positive classification of a predictive task. Each positive training document may contain a token/term per predictive identifier and may capture predictive identifiers over a timeframe that spans both before and after the assignment of the positive classification to the training entity.

In some examples, a negative class identifier document for a binary classification task may be generated using the training data store 508. For example, the negative class identifier document may be generated by identifying a second plurality of training entities from the training data store 508 that are associated with a negative class of the binary classification task. A second plurality of historical data objects may be received from the training data store 508 that correspond to the second plurality of training entities. The negative class identifier document may be generated by concatenating a plurality of negative class identifiers from each of the first plurality of historical data objects.

In some embodiments, the negative class identifier document includes a plurality of negative training documents for a negative classification of a predictive task. A negative class identifier document, for example, may include a negative training document for each of a plurality of training entities that are associated with a negative classification of a predictive task. Each negative training document may include a concatenation of a plurality of predictive identifiers extracted from one or more historical data objects associated with a respective training entity. In this manner, a plurality of entity-level training documents may be generated for a plurality of training entities associated with a negative classification of a predictive task. Each negative training document may contain a token/term per predictive identifier and may capture predictive identifiers over a timeframe that spans both before and after the assignment of the negative classification to the training entity.

In some embodiments, the plurality of task relevant identifiers is identified based on a comparison between the positive class identifier document and the negative class identifier document. For example, the plurality of task relevant identifiers may be identified by generating a plurality of positive frequency scores for the plurality of positive class identifiers based on the positive class identifier document, generating a plurality of negative frequency scores for the plurality of negative class identifiers based on the negative class identifier document, generating a plurality of feature importance measures based on a comparison between the plurality of positive frequency scores and the plurality of negative frequency scores, and identifying the plurality of task relevant identifiers based on the plurality of feature importance measures.

In some embodiments, a feature importance measure is a data value that describes a relative importance of a predictive identifier to an outcome of a predictive task. A feature importance measure, for example, may describe a strength of a correlation between a predictive identifier and a negative or positive classification of a binary classification outcome.

In some examples, a robust set of predictive identifiers 506 defined for a prediction domain may be filtered or pruned using a feature importance measure to generate a plurality of task relevant identifiers 510 tailored to a predictive task. The aim of this feature pruning is to retain predictive features relevant to a particular predictive task to improve the semantic information encoded for the particular predictive task. For example, only predictive identifiers 506 likely to contribute to and/or change a predictive classification for an entity may be retained as a task relevant identifier 510. The likelihood of a predictive identifier 506 contributing to and/or changing a predictive classification for an entity may be reflected by the feature importance measure.

In some embodiments, the feature importance measure is automatically generated for each of a plurality of predictive identifiers 506 with respect to a predictive task. The feature importance measure for a particular predictive identifier 506 may be generated based on a comparison between one or more frequency scores, such as a TF-IDF score, for the predictive identifier 506. The one or more frequency scores, for example, may be generated for each classification of a predictive task.

For example, a class identifier document may be generated for each classification of a predictive task to generate a plurality of class-specific documents for a predictive task. For a binary classification task, the plurality of class-specific documents may include positive class identifier document for a positive class and a negative class identifier document for a negative class. Once the plurality of class-specific documents is generated, a frequency score (e.g., TF-IDF score) of a predictive identifier 506 may be generated for each of the plurality of class-specific documents. The frequency score, for example, may include a TF-IDF score, which may be generated by determining the TF and IDF for the predictive identifier 506 across each of the plurality of class-specific documents using the equation below:

$$TF = \frac{number of times the term appears in the document}{total number of terms in the document}$$

$$IDF = Log ( \frac{n umber of documents in the corpus}{number of documents in the corpus containing the term} )$$

$$TF - IDF = TF \times IDF$$

In some examples, the frequency scores for a predictive identifier 506 may include (i) an average positive TF-IDF score corresponding to a positive class identifier document and (ii) an average negative TF-IDF score corresponding to a negative class identifier document. The average positive TF-IDF score, for example, may include an average TF-IDF score for a predictive identifier 506 amongst a plurality of training entities associated with a positive class (e.g., members that are eligible for Medicare, etc.) of the predictive task. The average negative TF-IDF score may include an average TF-IDF score for a predictive identifier amongst a plurality of training entities associated with a negative class (e.g., members that are not eligible for Medicare, etc.) of the predictive task. A feature importance measure may be generated by subtracting the average negative TF-IDF score from the average positive TF-IDF score.

In some embodiments, a predefined textual description 502 is identified for each of the task relevant identifiers. For example, a predictive identifier may be associated with a predefined textual description 502. The predefined textual description 502 may describe a predictive identifier without contextual information. Using some of the techniques of the present disclosure, a contextual text description 512 may be generated that includes an augmented predefined textual description that is augmented with contextual information to add additional context to the predefined textual description 502. In some examples, a source data store 504 may be accessed to map a predefined textual description to each of a plurality of predictive identifiers within a prediction domain.

In some embodiments, a predefined textual description 502 is a predefined text segment that corresponds to a predictive identifier 506. The predefined textual description 502, for example, may include a text segment from a source data store 504 for a predictive identifier 506. In some examples, the predefined textual description 502 may be retrieved for a particular predictive identifier from the source data store 504. In some examples, a source data store 504 may be accessed to map the predefined textual description 502 to each of a plurality of predictive identifiers 506 within a prediction domain.

In some embodiments, a generative text prompt 514 is generated for each of the task relevant identifiers based on the predefined textual descriptions 502. In some embodiments, a generative text prompt 514 is a generative model prompt for instructing a machine learning contextualization model 516 to generate a contextual text description 512. For example, the machine learning contextualization model 516 may be prompted with a generative text prompt 514 to add context to a predictive identifier 506 to provide additional predictive information for use by a downstream machine learning model. The generative text prompt 514, for example, may include a predefined textual description 502 for a predictive identifier and/or one or more natural language instructions for augmenting the predefined textual description 502 with information relevant to a predictive task. The one or more natural language instructions, for example, may include one or more configurable parameters that describe one or more contextual considerations associated with a predictive task. By way of example, in a clinical domain, the one or more configurable natural language instructions may request contextual information reflective of one or more symptoms of a condition corresponding to a predictive identifier 506. In some examples, the one or more configurable natural language instructions of generative text prompt 514 may be dynamically modified based on a performance of a downstream machine learning model for a predictive task.

In some embodiments, the contextual text description is generated for each of the plurality of task relevant identifiers using a machine learning contextualization model 516. For example, the generative text prompt 514 may be input to the machine learning contextualization model 516 to receive the contextual text description 512 for a task relevant identifier 510. For instance, a contextual text description 512 may be generated by inputting the generative text prompt 514, including the predefined textual description 502, to the machine learning contextualization model 516.

In some embodiments, the machine learning contextualization model is a data entity that describes parameters, hyper-parameters, and/or defined operations of a rules-based and/or machine learning model (e.g., model including at least one of one or more rule-based layers, one or more layers that depend on trained parameters, coefficients, and/or the like). A machine learning contextualization model 516 may include any type of model configured, trained, and/or the like to generate a contextual text description 512, as described herein. A machine learning contextualization model 516 may include one or more of any type of machine learning model including one or more supervised, unsupervised, semi-supervised, and/or reinforcement learning models. In some embodiments, the machine learning contextualization model 516 may include multiple models configured to perform one or more different stages of a generative text process.

In some examples, a machine learning contextualization model 516 may include a generative model configured to generate natural language text based on a generative prompt. For example, the generative model may include an LLM, such as a GPT model. In some examples, the generative model may include a GPT-3.5 model and/or any other machine learning model with generative capabilities. The generative model may be configured to generate a contextual text description 512 based on a generative text prompt 514 (e.g., a no shot prompt, few shot prompt, etc.) tailored to a predictive identifier 506.

The additional information provided by the machine learning contextualization model 516 may be tailored to a particular predictive task, where context may be an important factor. For example, in a clinical domain, understanding the symptoms of a condition may help to determine whether an individual's ability to work has been affected, which may help to determine whether they are likely to be eligible for social security benefits, and hence whether they may be eligible for Medicare.

In some embodiments, the plurality of task relevant identifiers 510 and a contextual text description 512 for each of the plurality of task relevant identifiers 510 is stored in the task-specific data store 424. In some examples, for a particular predictive task, a plurality of contextual text descriptions 512 may be generated for all task relevant identifiers 510 in an offline manner to allow for the real time retrieval of contextual text descriptions 512 during the inference. By way of example, each of the task relevant identifiers 510 may be stored in association with a corresponding contextual text description 512 within the task-specific data store 424.

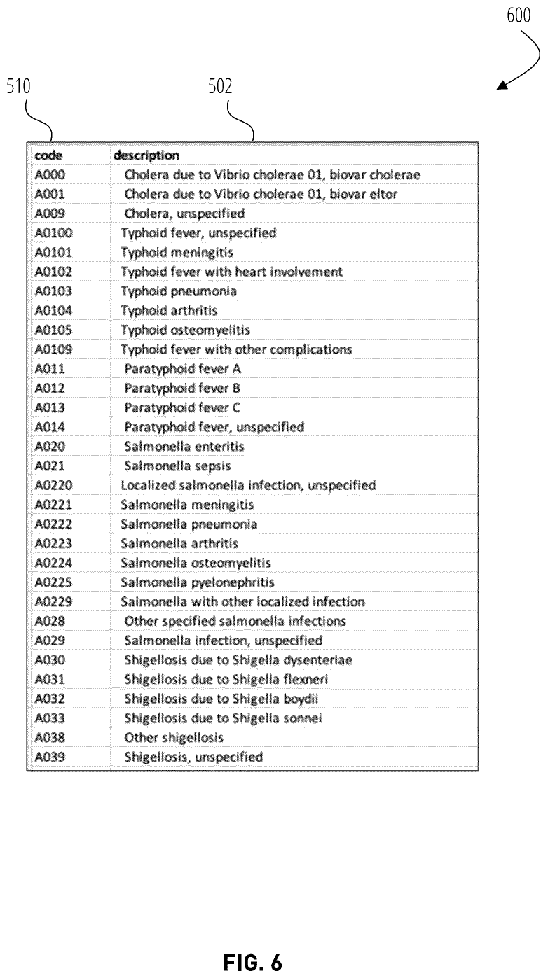

FIG. 6 is an operational example 600 of task relevant identifiers and corresponding predefined textual descriptions in accordance with some embodiments discussed herein. The operational example 600 provides a clinical example for illustration purposes. In the operational example 600, the plurality of task relevant identifier 510 may include a plurality of alpha-numeric medical codes. The predefined textual descriptions 502 may include a high-level code description for each of the medical codes.

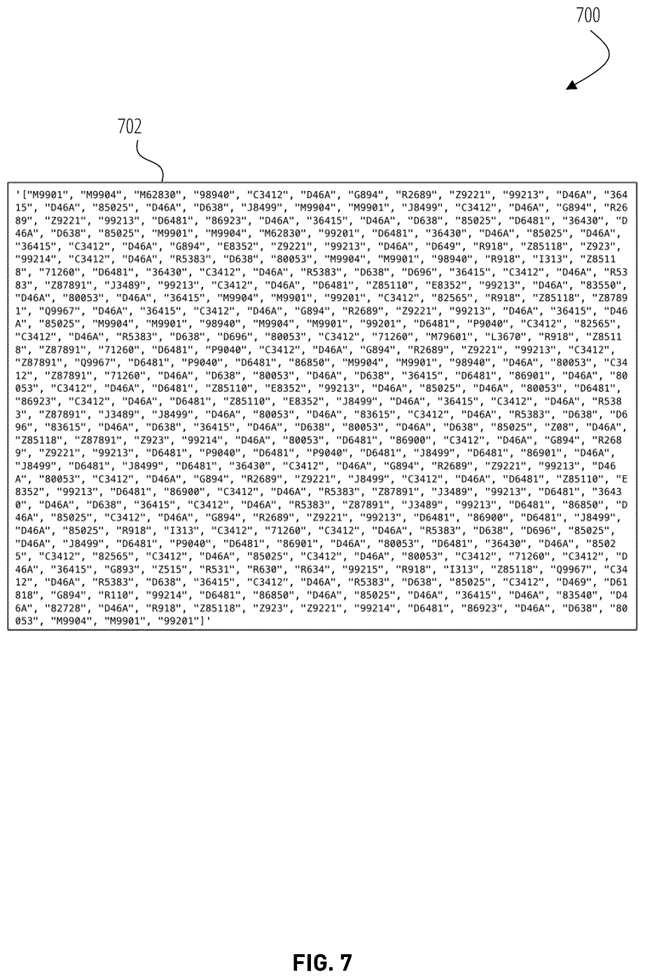

FIG. 7 is an operational example 700 of a class-specific document in accordance with some embodiments discussed herein. The operational example 700 provides a clinical example for illustration purposes. In the operational example 700, the class-specific document 702 may include a plurality of predictive identifiers (e.g., represented as alpha-numeric medical codes) that are concatenated to form the class-specific document.

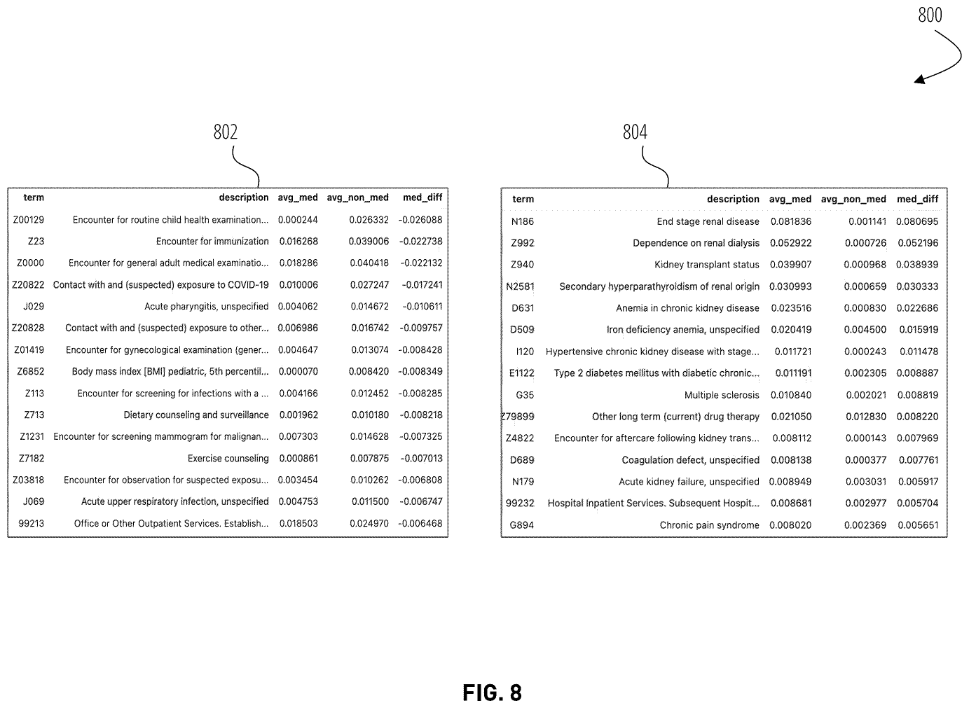

FIG. 8 is an operational example 800 of class-specific frequency scores for automatically identifying a plurality of task relevant identifiers in accordance with some embodiments discussed herein. The operational example 800 provides a clinical example for illustration purposes. In the operational example 800, the positive frequency scores 802 and the negative frequency scores 804 may include a set of frequency scores for each of a plurality of predictive identifiers (e.g., represented as alpha-numeric medical codes). The positive frequency scores 802, for example, may include an average positive frequency score, an average negative frequency score, and a feature importance measure that includes the difference between the average positive frequency score and the average negative frequency score for each positive class identifier from a positive class identifier document. The negative frequency scores 804, may include an average positive frequency score, an average negative frequency score, and a feature importance measure that includes the difference between the average positive frequency score and the average negative frequency score for each negative class identifier from a negative class identifier document.

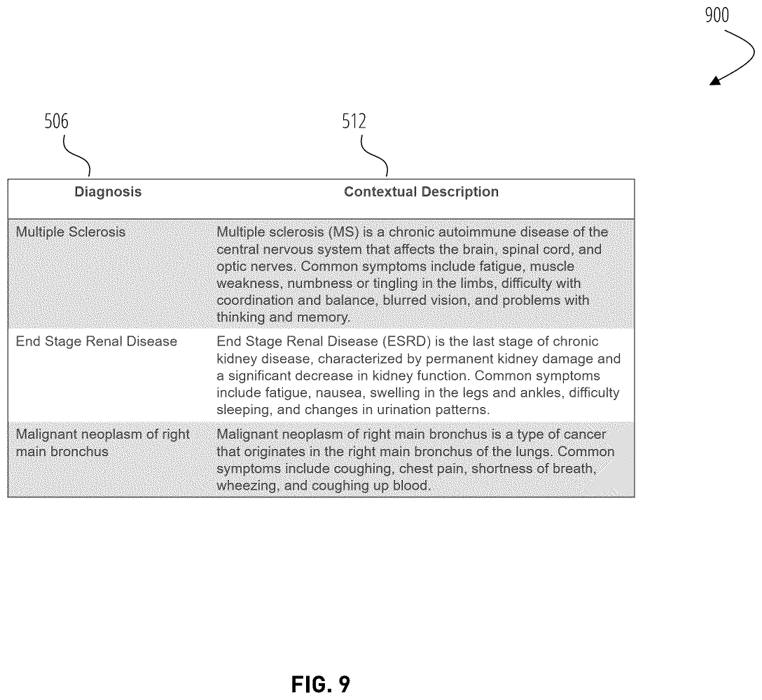

FIG. 9 is an operational example 900 of predictive identifiers and corresponding contextual text descriptions in accordance with some embodiments discussed herein. The operational example 900 provides a clinical example for illustration purposes. In the operational example 900, a predictive identifier 506 may be represented by a short text description for a medical code. As illustrated by the representative contextual text description 512, the contextual text description 512 for each predictive identifier 506 may include a long form natural language contextual description that provide contextual details not available from the predictive identifier 506.

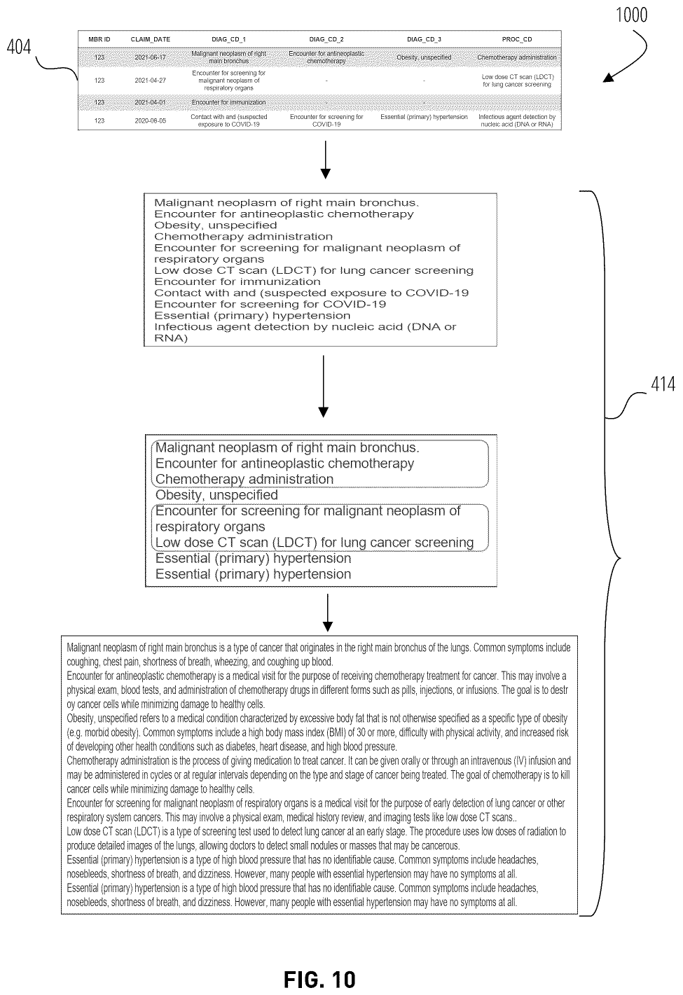

FIG. 10 is an operational example 1000 of one or more stages of a textual entity document in accordance with some embodiments discussed herein. The operational example 1000 provides a clinical example for illustration purposes. In the operational example 1000, the historical data objects 404 are represented by medical codes extracted from medical claims for an entity. As shown, the predefined textual descriptions for each of the extracted medical codes may be concatenated to form a first textual entity document 414. The textual entity document 414 may be modified to group identifier clusters to form a second textual entity document 414. The textual entity document 414 may then be expanded to a third textual entity document 414 with a dense textual representation of the medical codes extracted from medical claims for an entity.

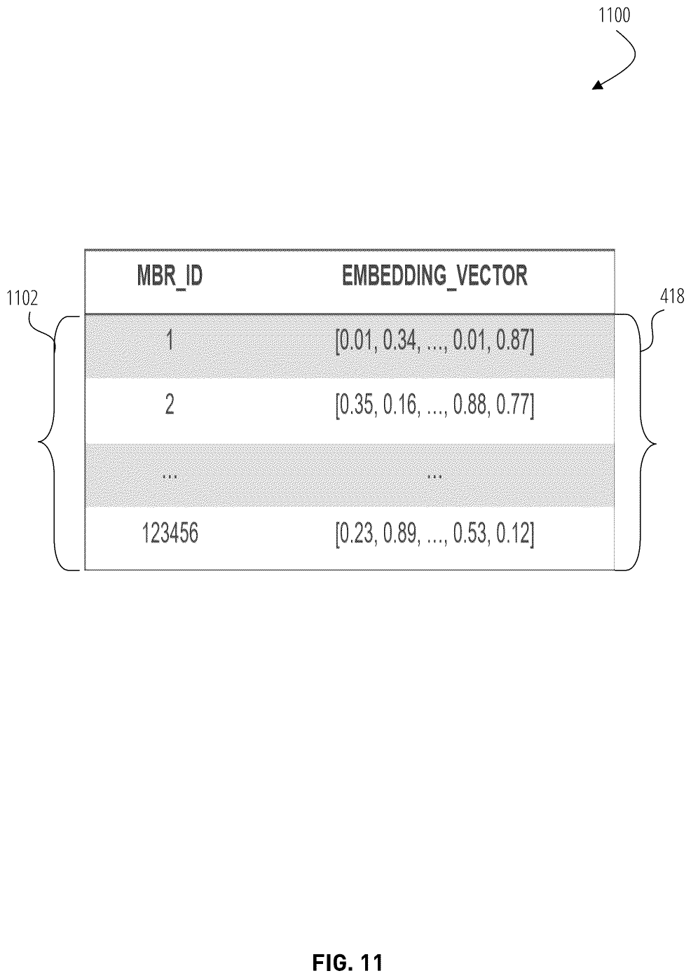

FIG. 11 is an operational example 1100 of contextual entity embeddings for an entity cohort in accordance with some embodiments discussed herein. In the operational example 1100, each entity is represented by an entity identifier and a contextual entity embedding. At inference time, the contextual entity embedding may be provided as input to a machine learning model to generate one or more predictions for the entity. In this manner, a single embedded vector may be stored and selectively accessed to generate predictive insights for an entity based on the dense textual representation engineered prior to inference. This allows for a reduction in memory resources required for various predictive tasks, while improving the performance of those predictive tasks.

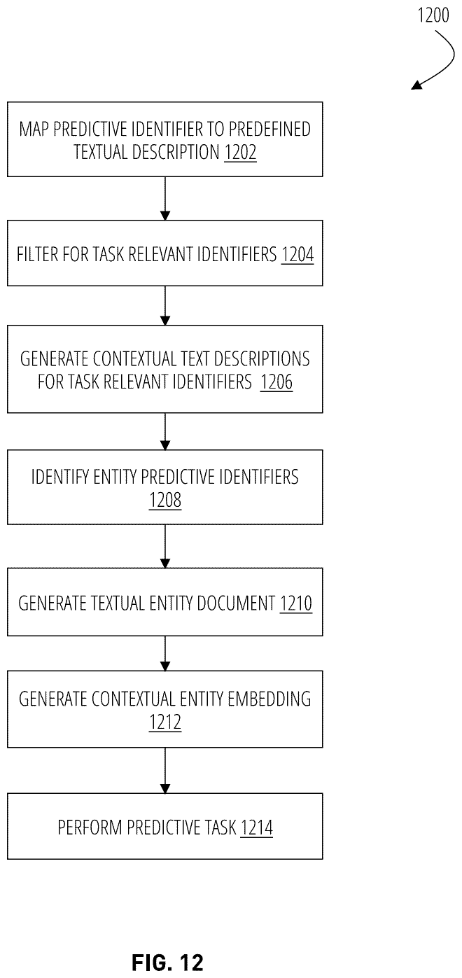

FIG. 12 is a flowchart diagram of an example feature engineering process 1200 for improving the performance of a predictive task in accordance with some embodiments discussed herein. The flowchart depicts a process 1200 for implementing a multi-stage feature engineering framework to engineer dense feature embeddings tailored to a predictive task. The process 1200 may be implemented by one or more computing devices, entities, and/or systems described herein. For example, via the various steps/operations of the process 1200, the computing system 101 may leverage improved feature engineering techniques to extract and generate contextual features for a predictive task and, using the extracted features, generate a condensed feature embedding that reduces memory resource requirements while improving the predictive performance of various predictive tasks. By doing so, the process 1200 facilitates a feature engineering pipeline that is directly tailored to addressing technical challenges of traditional machine learning technologies and may be leveraged to improve both the predictive performance and the training operations for traditional machine learning models.

FIG. 12 illustrates an example process 1200 for explanatory purposes. Although the example process 1200 depicts a particular sequence of steps/operations, the sequence may be altered without departing from the scope of the present disclosure. For example, some of the steps/operations depicted may be performed in parallel or in a different sequence that does not materially impact the function of the process 1200. In other examples, different components of an example device or system that implements the process 1200 may perform functions at substantially the same time or in a specific sequence.

In some embodiments, the process 1200 includes, at step/operation 1202, mapping predictive identifiers to predefined textual descriptions for the predictive identifiers. For example, the computing system 101 may identify a plurality of task relevant identifiers for a predictive task. The computing system 101 may identify a predefined textual description for the task relevant identifier.

In some embodiments, the process 1200 includes, at step/operation 1204, filtering the predictive identifiers for task relevant identifiers. For example, a predictive task may be a binary classification task and the computing system 101 may identify the plurality of task relevant identifiers based on a comparison between a positive class identifier document and a negative class identifier document corresponding to the binary classification task.

For example, the computing system 101 may generate a positive class identifier document by identifying a first plurality of training entities associated with a positive class of the binary classification task, receiving a first plurality of historical data objects corresponding to the first plurality of training entities, and generating the positive class identifier document by concatenating a plurality of positive class identifiers from each of the first plurality of historical data objects. The computing system 101 generate a negative class identifier document by identifying a second plurality of training entities associated with a negative class of the binary classification task, receiving a second plurality of historical data objects corresponding to the second plurality of training entities, and generating the negative class identifier document by concatenating a plurality of negative class identifiers from each of the second plurality of historical data objects.

In some examples, the computing system 101 may generate a plurality of positive frequency scores for the plurality of positive class identifiers based on the positive class identifier document. The computing system 101 may generate a plurality of negative frequency scores for the plurality of negative class identifiers based on the negative class identifier document. The computing system 101 may generate a plurality of feature importance measures based on a comparison between the plurality of positive frequency scores and the plurality of negative frequency scores. And the computing system 101 may identify the plurality of task relevant identifiers based on the plurality of feature importance measures.

In some embodiments, the process 1200 includes, at step/operation 1206, generating contextual text descriptions for the task relevant identifiers. For example, the computing system 101 may generate, using a machine learning contextualization model, the contextual text description for each of the plurality of task relevant identifiers. In some examples, the computing system 101 may store the plurality of task relevant identifiers and the contextual text description for each of the plurality of task relevant identifiers in a task-specific data store.

In some embodiments, the computing system 101 generates a generative text prompt based on a predefined textual description for a predictive identifier. The computing system 101 may input the generative text prompt to the machine learning contextualization model to receive the contextual text description for the task relevant identifier.

In some embodiments, the process 1200 includes, at step/operation 1208, identifying entity predictive identifiers for an entity. For example, the computing system 101 may identify a plurality of entity predictive identifiers from one or more historical data objects for an entity.

In some embodiments, the process 1200 includes, at step/operation 1210, generating a textual entity document for the entity. For example, the computing system 101 may generate, using a task-specific data store corresponding to a predictive task, a textual entity document for the entity by concatenating a set of contextual text descriptions from the task-specific data store that correspond to a set of task relevant identifiers from the plurality of entity predictive identifiers. In some examples, the computing system 101 may generate the textual entity document by identifying the set of task relevant identifiers from the plurality of entity predictive identifiers based on a comparison between the plurality of entity predictive identifiers and a plurality of task relevant identifiers from the task-specific data store, receiving, from the task-specific data store, the set of contextual text descriptions corresponding to the set of task relevant identifiers, and generating the textual entity document by concatenating the set of contextual text descriptions.

In some embodiments, the computing system 101 identifies, using a normalized co-occurrence matrix, one or more identifier clusters from the set of task relevant identifiers. Each identifier cluster may include a subset of related task relevant identifiers from the set of task relevant identifiers. The computing system 101 may modify the textual entity document by grouping a subset of contextual text descriptions from the set of contextual text descriptions that correspond to the subset of related task relevant identifiers.

In some examples, the normalized co-occurrence matrix may be generated based on a plurality of identifier frequencies across a plurality of historical data objects for a plurality of training entities. The plurality of identifier frequencies may identify a co-occurrence count reflective of a number of historical data objects that include a first predictive identifier and a second predictive identifier. The normalized co-occurrence matrix may include a normalized co-occurrence measure for the first predictive identifier and the second predictive identifier that is based on the co-occurrence count and a number of the plurality of historical data objects.

In some embodiments, the process 1200 includes, at step/operation 1212, generating a contextual entity embedding for the entity. For example, the computing system 101 may generate, using a machine learning encoder model, a contextual entity embedding for the entity based on the textual entity document. In some examples, the machine learning encoder model includes a neural network architecture and the contextual entity embedding includes a fixed length numerical vector representing a semantic relationship between the set of task relevant identifiers to the predictive task.

In some embodiments, the process 1200 includes, at step/operation 1214, performing a predictive task for the entity. For example, the computing system 101 may initiate, using the contextual entity embedding, one or more training operations for a machine learning classification model configured for the performance of the predictive task. In some examples, the computing system 101 may train, using the contextual entity embedding, the machine learning classification model for the performance of the predictive task.

Some techniques of the present disclosure enable the generation of action outputs that may be performed to initiate one or more real world actions to achieve real-world effects. The feature engineering techniques of the present disclosure may be used, applied, and/or otherwise leveraged to facilitate machine learning operations for a predictive task. The predictive task may trigger the performance of various computing tasks that improve the performance of a computing system (e.g., a computer itself, etc.) with respect to various actions performed by the computing system 101. Example actions may include the display, transmission, and/or the like of data reflective of a predictive task, such as alerts of a classification for an entity, and/or the like. Moreover, the actions may include physical actions, such as a control of a robotic machine (e.g., medical equipment based on a clinical classification, etc.), and/or the like, that may be triggered in response to a classification for a data object. A physical action, for example, may be caused by executing one or more control instructions in response to a predictive action.

In some examples, the computing tasks may include actions that may be based on a prediction domain. A prediction domain may include any environment in which computing systems may be applied to generate predictive insights and initiate the performance of computing tasks responsive to the predictive insights. These actions may cause real-world changes, for example, by controlling a hardware component, providing alerts, interactive actions, and/or the like. For instance, actions may include the initiation of automated instructions across and between devices, automated notifications, automated scheduling operations, automated precautionary actions, automated security actions, automated data processing actions, and/or the like.

### VI. CONCLUSION

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may include a single computing entity that is configured to perform all of the steps/operations of a particular example. In addition, or alternatively, a computing system may include multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising identifying, by one or more processors, a plurality of entity predictive identifiers from one or more historical data objects for an entity; generating, by the one or more processors and using a task-specific data store corresponding to a predictive task, a textual entity document for the entity by concatenating a set of contextual text descriptions from the task-specific data store that correspond to a set of task relevant identifiers from the plurality of entity predictive identifiers; generating, by the one or more processors and using a machine learning encoder model, a contextual entity embedding for the entity based on the textual entity document; and initiating, by the one or more processors and using the contextual entity embedding, one or more training operations for a machine learning classification model configured for the performance of the predictive task.

Example 2. The computer-implemented method of example 1, wherein the machine learning encoder model comprises a neural network architecture and the contextual entity embedding comprises a fixed length numerical vector representing a semantic relationship between the set of task relevant identifiers to the predictive task.

Example 3. The computer-implemented method of any of the preceding examples, wherein generating the textual entity document comprises identifying the set of task relevant identifiers from the plurality of entity predictive identifiers based on a comparison between the plurality of entity predictive identifiers and a plurality of task relevant identifiers from the task-specific data store; receiving, from the task-specific data store, the set of contextual text descriptions corresponding to the set of task relevant identifiers; and generating the textual entity document by concatenating the set of contextual text descriptions.

Example 4. The computer-implemented method of any of the preceding examples, further comprising identifying, using a normalized co-occurrence matrix, one or more identifier clusters from the set of task relevant identifiers, wherein each identifier cluster comprises a subset of related task relevant identifiers from the set of task relevant identifiers; and modifying the textual entity document by grouping a subset of contextual text descriptions from the set of contextual text descriptions that correspond to the subset of related task relevant identifiers.

Example 5. The computer-implemented method of example 4, wherein the normalized co-occurrence matrix is generated based on a plurality of identifier frequencies across a plurality of historical data objects for a plurality of training entities.

Example 6. The computer-implemented method of example 5, wherein the plurality of identifier frequencies identifies a co-occurrence count reflective of a number of historical data objects that comprise a first predictive identifier and a second predictive identifier.

Example 7. The computer-implemented method of example 6, wherein the normalized co-occurrence matrix comprises a normalized co-occurrence measure for the first predictive identifier and the second predictive identifier that is based on the co-occurrence count and a number of the plurality of historical data objects.

Example 8. The computer-implemented method of any of the preceding examples, wherein the task-specific data store is generated by identifying a plurality of task relevant identifiers for the predictive task; generating, using a machine learning contextualization model, a contextual text description for each of the plurality of task relevant identifiers; and storing the plurality of task relevant identifiers and the contextual text description for each of the plurality of task relevant identifiers.

Example 9. The computer-implemented method of example 8, wherein generating a particular contextual text description for a task relevant identifier comprises identifying a predefined textual description for the task relevant identifier; generating a generative text prompt based on the predefined textual description; and inputting the generative text prompt to the machine learning contextualization model to receive the particular contextual text description for the task relevant identifier.

Example 10. The computer-implemented method of examples 8 or 9, wherein the predictive task is a binary classification task and identifying the plurality of task relevant identifiers comprises generating a positive class identifier document by identifying a first plurality of training entities associated with a positive class of the binary classification task, receiving a first plurality of historical data objects corresponding to the first plurality of training entities, and generating the positive class identifier document by concatenating a plurality of positive class identifiers from each of the first plurality of historical data objects; generating a negative class identifier document by identifying a second plurality of training entities associated with a negative class of the binary classification task, receiving a second plurality of historical data objects corresponding to the second plurality of training entities, and generating the negative class identifier document by concatenating a plurality of negative class identifiers from each of the second plurality of historical data objects; and identifying the plurality of task relevant identifiers based on a comparison between the positive class identifier document and the negative class identifier document.

Example 11. The computer-implemented method of example 10, wherein identifying the plurality of task relevant identifiers based on the comparison between the positive class identifier document and the negative class identifier document comprises generating a plurality of positive frequency scores for the plurality of positive class identifiers based on the positive class identifier document; generating a plurality of negative frequency scores for the plurality of negative class identifiers based on the negative class identifier document; generating a plurality of feature importance measures based on a comparison between the plurality of positive frequency scores and the plurality of negative frequency scores; and identifying the plurality of task relevant identifiers based on the plurality of feature importance measures.

Example 12. A computing system comprising memory and one or more processors communicatively coupled to the memory, the one or more processors configured to identify a plurality of entity predictive identifiers from one or more historical data objects for an entity; generate, using a task-specific data store corresponding to a predictive task, a textual entity document for the entity by concatenating a set of contextual text descriptions from the task-specific data store that correspond to a set of task relevant identifiers from the plurality of entity predictive identifiers; generate, using a machine learning encoder model, a contextual entity embedding for the entity based on the textual entity document; and initiate, using the contextual entity embedding, one or more training operations for a machine learning classification model configured for the performance of the predictive task.

Example 13. The computing system of example 12, wherein the machine learning encoder model comprises a neural network architecture and the contextual entity embedding comprises a fixed length numerical vector representing a semantic relationship between the set of task relevant identifiers to the predictive task.

Example 14. The computing system of examples 12 or 13, wherein generating the textual entity document comprises identifying the set of task relevant identifiers from the plurality of entity predictive identifiers based on a comparison between the plurality of entity predictive identifiers and a plurality of task relevant identifiers from the task-specific data store; receiving, from the task-specific data store, the set of contextual text descriptions corresponding to the set of task relevant identifiers; and generating the textual entity document by concatenating the set of contextual text descriptions.

Example 15. The computing system of example 12, wherein the one or more processors are further configured to identifying, using a normalized co-occurrence matrix, one or more identifier clusters from the set of task relevant identifiers, wherein each identifier cluster comprises a subset of related task relevant identifiers from the set of task relevant identifiers; and modifying the textual entity document by grouping a subset of contextual text descriptions from the set of contextual text descriptions that correspond to the subset of related task relevant identifiers.

Example 16. The computing system of example 15, wherein the normalized co-occurrence matrix is generated based on a plurality of identifier frequencies across a plurality of historical data objects for a plurality of training entities.

Example 17. The computing system of example 16, wherein the plurality of identifier frequencies identifies a co-occurrence count reflective of a number of historical data objects that comprise a first predictive identifier and a second predictive identifier.

Example 18. The computing system of example 17, wherein the normalized co-occurrence matrix comprises a normalized co-occurrence measure for the first predictive identifier and the second predictive identifier that is based on the co-occurrence count and a number of the plurality of historical data objects.

Example 19. One or more non-transitory computer-readable storage media including instructions that, when executed by one or more processors, cause the one or more processors to identify a plurality of entity predictive identifiers from one or more historical data objects for an entity; generate, using a task-specific data store corresponding to a predictive task, a textual entity document for the entity by concatenating a set of contextual text descriptions from the task-specific data store that correspond to a set of task relevant identifiers from the plurality of entity predictive identifiers; generate, using a machine learning encoder model, a contextual entity embedding for the entity based on the textual entity document; and initiate, using the contextual entity embedding, one or more training operations for a machine learning classification model configured for the performance of the predictive task.

Example 20. The one or more non-transitory computer-readable storage media of example 19, wherein the task-specific data store is generated by identifying a plurality of task relevant identifiers for the predictive task; generating, using a machine learning contextualization model, a contextual text description for each of the plurality of task relevant identifiers; and storing the plurality of task relevant identifiers and the contextual text description for each of the plurality of task relevant identifiers.

Example 21. The computer-implemented method of example 1, wherein the machine learning classification model is a supervised machine learning classifier and the computer-implemented method further comprises receiving training data for the machine learning classification model, wherein the training data comprises a plurality of labeled contextual entity embeddings; and training, via one or more supervised training techniques, the machine learning classification model using the training data, wherein the one or more supervised training techniques comprise back propagation of errors and the machine learning classification model is trained to optimize a classification loss.

Example 22: The computer-implemented method of example 21, wherein the training is performed by the one or more processors.

Example 23: The computer-implemented method of example 21, wherein the one or more processors are included in a first computing entity; and the training is performed by one or more other processors included in a second computing entity.

Example 24. The computing system of example 12, wherein the machine learning classification model is a supervised machine learning classifier and the one or more processors are further configured to receive training data for the machine learning classification model, wherein the training data comprises a plurality of labeled contextual entity embeddings; and train, via one or more supervised training techniques, the machine learning classification model using the training data, wherein the one or more supervised training techniques comprise back propagation of errors and the machine learning classification model is trained to optimize a classification loss.

Example 25: The computing system of example 24, wherein the training is performed by the one or more processors.

Example 26: The computing system of example 24, wherein the one or more processors are included in a first computing entity; and the training is performed by one or more other processors included in a second computing entity.

Example 27. The one or more non-transitory computer-readable storage media of example 19, wherein the machine learning classification model is a supervised machine learning classifier and the one or more processors are further configured to receive training data for the machine learning classification model, wherein the training data comprises a plurality of labeled contextual entity embeddings; and train, via one or more supervised training techniques, the machine learning classification model using the training data, wherein the one or more supervised training techniques comprise back propagation of errors and the machine learning classification model is trained to optimize a classification loss.

Example 28: The one or more non-transitory computer-readable storage media of example 27, wherein the training is performed by the one or more processors.

Example 29: The one or more non-transitory computer-readable storage media of example 27, wherein the one or more processors are included in a first computing entity; and the training is performed by one or more other processors included in a second computing entity.

1. A computer-implemented method comprising:
identifying, by one or more processors, a plurality of entity predictive identifiers from one or more historical data objects for an entity;
generating, by the one or more processors and using a task-specific data store corresponding to a predictive task, a textual entity document for the entity by concatenating a set of contextual text descriptions from the task-specific data store that correspond to a set of task relevant identifiers from the plurality of entity predictive identifiers;
generating, by the one or more processors and using a machine learning encoder model, a contextual entity embedding for the entity based on the textual entity document; and
initiating, by the one or more processors and using the contextual entity embedding, one or more training operations for a machine learning classification model configured for the performance of the predictive task.

2. The computer-implemented method of claim 1, wherein the machine learning encoder model comprises a neural network architecture and the contextual entity embedding comprises a fixed length numerical vector representing a semantic relationship between the set of task relevant identifiers to the predictive task.

3. The computer-implemented method of claim 1, wherein generating the textual entity document comprises:
identifying the set of task relevant identifiers from the plurality of entity predictive identifiers based on a comparison between the plurality of entity predictive identifiers and a plurality of task relevant identifiers from the task-specific data store;
receiving, from the task-specific data store, the set of contextual text descriptions corresponding to the set of task relevant identifiers; and
generating the textual entity document by concatenating the set of contextual text descriptions.

4. The computer-implemented method of claim 1, further comprising:
identifying, using a normalized co-occurrence matrix, one or more identifier clusters from the set of task relevant identifiers, wherein each identifier cluster comprises a subset of related task relevant identifiers from the set of task relevant identifiers; and
modifying the textual entity document by grouping a subset of contextual text descriptions from the set of contextual text descriptions that correspond to the subset of related task relevant identifiers.

5. The computer-implemented method of claim 4, wherein the normalized co-occurrence matrix is generated based on a plurality of identifier frequencies across a plurality of historical data objects for a plurality of training entities.

6. The computer-implemented method of claim 5, wherein the plurality of identifier frequencies identifies a co-occurrence count reflective of a number of historical data objects that comprise a first predictive identifier and a second predictive identifier.

7. The computer-implemented method of claim 6, wherein the normalized co-occurrence matrix comprises a normalized co-occurrence measure for the first predictive identifier and the second predictive identifier that is based on the co-occurrence count and a number of the plurality of historical data objects.

8. The computer-implemented method of claim 1, wherein the task-specific data store is generated by:
identifying a plurality of task relevant identifiers for the predictive task;
generating, using a machine learning contextualization model, a contextual text description for each of the plurality of task relevant identifiers; and
storing the plurality of task relevant identifiers and the contextual text description for each of the plurality of task relevant identifiers.

9. The computer-implemented method of claim 8, wherein generating a particular contextual text description for a task relevant identifier comprises:
identifying a predefined textual description for the task relevant identifier;
generating a generative text prompt based on the predefined textual description; and
inputting the generative text prompt to the machine learning contextualization model to receive the particular contextual text description for the task relevant identifier.

10. The computer-implemented method of claim 8, wherein the predictive task is a binary classification task and identifying the plurality of task relevant identifiers comprises:
generating a positive class identifier document by:
identifying a first plurality of training entities associated with a positive class of the binary classification task,
receiving a first plurality of historical data objects corresponding to the first plurality of training entities, and
generating the positive class identifier document by concatenating a plurality of positive class identifiers from each of the first plurality of historical data objects;
generating a negative class identifier document by:
identifying a second plurality of training entities associated with a negative class of the binary classification task,
receiving a second plurality of historical data objects corresponding to the second plurality of training entities, and
generating the negative class identifier document by concatenating a plurality of negative class identifiers from each of the second plurality of historical data objects; and
identifying the plurality of task relevant identifiers based on a comparison between the positive class identifier document and the negative class identifier document.

11. The computer-implemented method of claim 10, wherein identifying the plurality of task relevant identifiers based on the comparison between the positive class identifier document and the negative class identifier document comprises:
generating a plurality of positive frequency scores for the plurality of positive class identifiers based on the positive class identifier document;
generating a plurality of negative frequency scores for the plurality of negative class identifiers based on the negative class identifier document;
generating a plurality of feature importance measures based on a comparison between the plurality of positive frequency scores and the plurality of negative frequency scores; and
identifying the plurality of task relevant identifiers based on the plurality of feature importance measures.

12. A computing system comprising memory and one or more processors communicatively coupled to the memory, the one or more processors configured to:
identify a plurality of entity predictive identifiers from one or more historical data objects for an entity;
generate, using a task-specific data store corresponding to a predictive task, a textual entity document for the entity by concatenating a set of contextual text descriptions from the task-specific data store that correspond to a set of task relevant identifiers from the plurality of entity predictive identifiers;
generate, using a machine learning encoder model, a contextual entity embedding for the entity based on the textual entity document; and
initiate, using the contextual entity embedding, one or more training operations for a machine learning classification model configured for the performance of the predictive task.

13. The computing system of claim 12, wherein the machine learning encoder model comprises a neural network architecture and the contextual entity embedding comprises a fixed length numerical vector representing a semantic relationship between the set of task relevant identifiers to the predictive task.

14. The computing system of claim 12, wherein generating the textual entity document comprises:
identifying the set of task relevant identifiers from the plurality of entity predictive identifiers based on a comparison between the plurality of entity predictive identifiers and a plurality of task relevant identifiers from the task-specific data store;
receiving, from the task-specific data store, the set of contextual text descriptions corresponding to the set of task relevant identifiers; and
generating the textual entity document by concatenating the set of contextual text descriptions.

15. The computing system of claim 12, wherein the one or more processors are further configured to:
identifying, using a normalized co-occurrence matrix, one or more identifier clusters from the set of task relevant identifiers, wherein each identifier cluster comprises a subset of related task relevant identifiers from the set of task relevant identifiers; and
modifying the textual entity document by grouping a subset of contextual text descriptions from the set of contextual text descriptions that correspond to the subset of related task relevant identifiers.

16. The computing system of claim 15, wherein the normalized co-occurrence matrix is generated based on a plurality of identifier frequencies across a plurality of historical data objects for a plurality of training entities.

17. The computing system of claim 16, wherein the plurality of identifier frequencies identifies a co-occurrence count reflective of a number of historical data objects that comprise a first predictive identifier and a second predictive identifier.

18. The computing system of claim 17, wherein the normalized co-occurrence matrix comprises a normalized co-occurrence measure for the first predictive identifier and the second predictive identifier that is based on the co-occurrence count and a number of the plurality of historical data objects.

19. One or more non-transitory computer-readable storage media including instructions that, when executed by one or more processors, cause the one or more processors to:
identify a plurality of entity predictive identifiers from one or more historical data objects for an entity;
generate, using a task-specific data store corresponding to a predictive task, a textual entity document for the entity by concatenating a set of contextual text descriptions from the task-specific data store that correspond to a set of task relevant identifiers from the plurality of entity predictive identifiers;
generate, using a machine learning encoder model, a contextual entity embedding for the entity based on the textual entity document; and
initiate, using the contextual entity embedding, one or more training operations for a machine learning classification model configured for the performance of the predictive task.

20. The one or more non-transitory computer-readable storage media of claim 19, wherein the task-specific data store is generated by:
identifying a plurality of task relevant identifiers for the predictive task;
generating, using a machine learning contextualization model, a contextual text description for each of the plurality of task relevant identifiers; and
storing the plurality of task relevant identifiers and the contextual text description for each of the plurality of task relevant identifiers.
